(19) United States
(12) Patent Application Publication
(10) Pub. No.: US 2025/0191361 A1
(43) Pub. Date: Jun. 12, 2025

(54) FACTORY MUSHROOM PICKING ROBOT AND VISION-BASED GRADED PICKING METHOD

(71) Applicant: AGRICULTURAL INFORMATION INSTITUTE OF CAAS, Beijing (CN)

(72) Inventors: Xiujuan CHAI, Beijing (CN); Shulong ZHAO, Beijing (CN); Shuo ZHOU, Beijing (CN); Ning ZHANG, Beijing (CN); Qixin SUN, Beijing (CN); Tan SUN, Beijing (CN)

(21) Appl. No.: 19/053,006

(22) Filed: Feb. 13, 2025

Related U.S. Application Data
(63) Continuation of application No. PCT/CN2024/075752, filed on Feb. 4, 2024.

(30) Foreign Application Priority Data
Jan. 22, 2024 (CN) 202410089130.0

(51) Int. Cl. G06V 20/10; A01D 46/30; A01G 18/62; A01G 18/70; B25J 11/00; G06V 10/764; G06V 10/774; G06V 10/82; H04N 23/54; H04N 23/695

(52) U.S. Cl. CPC G06V 20/188; A01D 46/30; A01G 18/70; B25J 11/0045; G06V 10/764; G06V 10/774; G06V 10/82; H04N 23/54; H04N 23/695; A01G 18/62

(57) ABSTRACT

A factory mushroom picking robot includes a mobile platform, a chassis (100), a lifting device (200), a mushroom stick take-up device (300) and a mushroom picking device (400). The mushroom stick take-up device (300) is configured to take mushroom sticks out of a mushroom rack (4), and the mushroom sticks from different layers are taken through the lifting device (200). The mushroom picking device (400) includes a mechanical arm (402) and an execution end (403). The image data of the mushroom sticks are acquired through three depth cameras. Mushroom targets to be picked are identified through multi-view target matching and are divided in terms of the quality grade, so as to achieve graded picking. A vision-based graded picking method, a mushroom detection and grading method based on multi-view fusion and a non-transitory storage medium of executing corresponding method are further provided.

### CROSS REFERENCE TO RELATED APPLICATION

This patent application is a continuation-in-part of International Application No. PCT/CN2024/075752, filed on Feb. 4, 2024, which claims the benefit and priority of Chinese Patent Application No. 202410089130.0 filed with the China National Intellectual Property Administration on Jan. 22, 2024, the disclosure of which both of the aforementioned applications are incorporated by reference herein in its their entirety entireties as part of the present application.

### TECHNICAL FIELD

The present disclosure relates to the technical field of industrialized mushroom planting, in particular to a factory mushroom picking robot and a vision-based graded picking method.

### BACKGROUND

It is well-known that a mushroom is an edible fungus, which is rich in nutrition, high in protein and low in fat, and has polysaccharide, various amino acids and vitamins.

Mushroom planting has been industrialized. The environment in the factory meets the conditions of temperature, humidity and light suitable for the growth of mushrooms. A large number of mushroom racks are installed in the factory. Mushroom sticks are placed on the mushroom racks. The mushroom sticks are used for growing mushrooms. A mushroom rack is provided with many layers, the space of each layer is small, and a plurality of mushroom sticks are placed on each layer of the mushroom rack. For the basic structure of the mushroom rack, which refers to the Utility Model Patent with the granted publication number of CN215454376U entitled as “MUSHROOM STICK PLANTING RACK”.

At present, most of the mushrooms that have grown mature on the mushroom sticks are picked manually, which has the problems of a heavy labor intensity, a high labor cost and a low efficiency, and has a phenomenon of missing picking.

There are a few automatic picking robots replacing manual picking in the market, which refers to Invention Patent Applications with the publication numbers of CN116458388A and CN116671392A. However, the automatic picking effect is not ideal, which is shown in the following aspects: low in picking efficiency, low in degree of automation, easy to damage a mushroom cap, easy to damage a mushroom stick and unable to accurately identify mature mushrooms. In the Invention Patent Applications with the publication numbers of CN116458388A and CN116671392A, it is easy to damage the mushroom cap by holding the mushroom with flexible fingers and then picking the mushroom from the mushroom stick.

### SUMMARY

In order to solve the technical problems that the existing automatic picking robot for picking mushrooms is low in picking efficiency, low in degree of automation, easy to damage a mushroom cap, easy to damage a mushroom stick and unable to accurately identify mature mushrooms, the present disclosure provides a factory mushroom picking robot and a vision-based graded picking method.

The factory mushroom picking robot according to the present disclosure takes mushroom sticks out of a mushroom rack, and takes the mushroom sticks from different layers through the lifting device. The mushrooms that can be picked are picked by the execution end, and the mushroom sticks are placed back on the mushroom rack after picking the mushrooms.

The present disclosure provides a factory mushroom picking robot, including a mobile platform, a chassis, a lifting device, a mushroom stick take-up device and a mushroom picking device, wherein the chassis is connected with the mobile platform, the lifting device is connected with the chassis, the mushroom stick take-up device is connected with the lifting device, and the mushroom picking device is connected with the chassis.

The lifting device includes a first fixed plate, a second fixed plate, a first electric cylinder, a second electric cylinder and a support plate, wherein the first electric cylinder is fixedly connected with the first fixed plate, the second electric cylinder is fixedly connected with the second fixed plate, the first electric cylinder and the second electric cylinder are vertically arranged side by side, the first electric cylinder is provided with a first slider, the second electric cylinder is provided with a second slider, one end of the support plate is connected with the first slider on the first electric cylinder, and the other end of the support plate is connected with the second slider on the second electric cylinder; the first fixed plate is fixedly connected with the chassis, and the second fixed plate is fixedly connected with the chassis.

The mushroom stick take-up device includes a first base, a first guide rail component, a second guide rail component, a Y-axis-direction screw rod, a nut, a first driving motor, a first synchronous belt wheel, a second synchronous belt wheel, a first synchronous belt, a sliding plate, a second base, a third guide rail component, an X-axis-direction bidirectional screw rod, a slider I, a slider II, an L-shaped connecting plate I, an L-shaped connecting plate II, a clamping rod I, a clamping rod II, a nut seat I, a nut seat II, a second driving motor, a third synchronous belt wheel, a fourth synchronous belt wheel, and a second synchronous belt, wherein the first guide rail component and the second guide rail component are fixedly connected with the first base, the first guide rail component and the second guide rail component are arranged side by side, a front end of the Y-axis-direction screw rod is rotatably connected with a front portion of the first base through a bearing, a rear end of the Y-axis-direction screw rod is rotatably connected with a rear portion of the first base through a bearing, the Y-axis-direction screw rod is located between the first guide rail component and the second guide rail component, the first driving motor is connected with a rear portion of the first base, the first synchronous belt wheel is connected with an output shaft of the first driving motor, the second synchronous belt wheel is connected with a rear end of the Y-axis-direction screw rod, the first synchronous belt is connected between the first synchronous belt wheel and the second synchronous belt wheel, the nut is connected with the Y-axis-direction screw rod, the sliding plate is fixedly connected with the nut, one side of the sliding plate is fixedly connected with the slider on the first guide rail component, the other side of the sliding plate is fixedly connected with the slider on the second guide rail component, the second base is fixedly connected with the sliding plate, the third guide rail component is fixedly connected with the second base, a left end of the X-axis-direction bidirectional screw rod is rotatably connected with a left portion of the second base through a bearing, a right end of the X-axis-direction bidirectional screw rod is rotatably connected with a right portion of the second base through a bearing, the nut seat I and the nut seat II are connected with the X-axis-direction bidirectional screw rod, the slider I is fixedly connected with the nut seat I, the slider II is fixedly connected with the nut seat II, the L-shaped connecting plate I is fixedly connected with the slider I, the L-shaped connecting plate II is fixedly connected with the slider II, the second driving motor is fixedly connected with a left portion of the second base, the third synchronous belt wheel is connected with an output shaft of the second driving motor, the fourth synchronous belt wheel is connected with a left end of the X-axis-direction bidirectional screw rod, the second synchronous belt is connected between the third synchronous belt wheel and the fourth synchronous belt wheel, a rear end of the clamping rod I is fixedly connected with the L-shaped connecting plate I, a rear end of the clamping rod II is fixedly connected with the L-shaped connecting plate II, and the first base is fixedly connected with the support plate of the lifting device.

The mushroom picking device includes a lifting mechanism, a mechanical arm and an execution end, wherein the lifting mechanism is fixedly connected with the chassis, the mechanical arm is connected with the lifting mechanism, and the execution end is connected with a free end of the mechanical arm; the execution end includes a support frame, a clamping driving motor, a screw rod, a screw rod nut, a connecting block, a first connecting rod, a first V-shaped connecting rod, a second connecting rod, a second V-shaped connecting rod, a first clamping block and a second clamping block, wherein the clamping driving motor is fixedly connected with the support frame, the screw rod is fixedly connected with an output shaft of the clamping driving motor, the screw rod nut is connected with the screw rod, the connecting block is fixedly connected with the screw rod nut, a rear end of the first connecting rod is rotatably connected with the connecting block, a front end of the first connecting rod is rotatably connected with a rear end of the first V-shaped connecting rod, a middle portion of the first V-shaped connecting rod is rotatably connected with the support frame, a rear end of the second connecting rod is rotatably connected with the connecting block, a front end of the second connecting rod is rotatably connected with a rear end of the second V-shaped connecting rod, a middle portion of the second V-shaped connecting rod is rotatably connected with the support frame, the first connecting rod and the second connecting rod are arranged symmetrically to each other, the first V-shaped connecting rod and the second V-shaped connecting rod are arranged symmetrically to each other, the first clamping block is connected with a front end of the first V-shaped connecting rod, and the second clamping block is connected with a front end of the second V-shaped connecting rod; the first clamping block is provided with an arc-shaped groove, and the second clamping block is provided with an arc-shaped groove.

The support frame of the execution end is fixedly connected with the free end of the mechanical arm.

The lifting mechanism is located between the first electric cylinder and the second electric cylinder of the lifting device.

In one embodiment, an inner side of the clamping rod I of the mushroom stick take-up device is provided with an inclined surface, and an inner side of the clamping rod II of the mushroom stick take-up device is provided with an inclined surface.

Preferably, the picking device further includes a mushroom identification depth camera, and the mushroom identification depth camera is connected with the support frame of the execution end.

The present disclosure further provides a vision-based graded picking method using the factory mushroom picking robot, wherein the picking device further includes a mushroom identification depth camera, the mushroom identification depth camera is connected with a support frame of an execution end, the support plate is connected with a first depth camera through a first adjustable bracket, and the support plate is connected with a second depth camera through a second adjustable bracket; and the vision-based graded picking method includes the following steps:

Step 1: constructing a multi-view data set for training a mushroom object detection model:
Step (1): acquiring video data of a mushroom stick using a depth camera, where the depth camera is initially located directly above the mushroom stick with an overhead shot looking down, and after video shooting, is moved around a side of the mushroom stick at a constant speed and stops recording video data upon being moved to a lower left side of the mushroom stick and having mushroom pleats be shot upward, so as to complete acquisition of a first video data of the mushroom stick; thereafter, recording a second video data, wherein the depth camera is initially located directly above the mushroom stick with an overhead shot looking down, and after video shooting, is moved around a side of the mushroom stick at a constant speed and stops recording video data upon being moved to the lower right side of the mushroom stick and having mushroom pleats be shot upward, so as to complete acquisition of a second video data of the mushroom stick; and acquiring a plurality of videos for a plurality of mushroom sticks;
Step (2): obtaining still images of mushrooms, comprises: obtaining frame-extracted images by extracting frames from each video stream of the plurality of mushroom sticks, and screening a set of a large number of mushroom object detection data from the frame-extracted images, wherein the mushroom object detection data set comprises mushroom cap images with a top view and mushroom pleat images with a bottom view; and
Step (3): labeling the data set according to six quality categories including white, normal, abnormal, un-open, slightly open and fully open;
Step 2: training the mushroom object detection model based on a YOLOv8 deep learning algorithm:

Step (1): training the model:
based on a basic structure of the YOLOv8 object detection model, pruning a detection head of a P3 layer, and an entire P5 layer, and retaining only the output of a detection head of a P4 layer, thus forming the mushroom object detection model; and training the mushroom object detection model by using the mushroom object detection data set constructed in the Step 1;
Step (2), performing a multi-view target matching; wherein the mushroom cap with a top view is shot using the mushroom identification depth camera, the mushroom pleats with a bottom view are shot using the first depth camera and the second depth camera, the three images shot by the mushroom identification depth camera, the first depth camera and the second depth camera are combined into a batch, the batch is input into the mushroom object detection model to obtain mushroom detection results from three views (i.e. a top view, a right bottom view and a left bottom view): det_d, det_ur and det_ul; the mushroom cap is matched with the mushroom pleats using a rule-based method; first, a detection frame in det_d is divided into an upper part det_dr and a lower part det_dl with a middle line of a picture in a width direction as a dividing line, it is assumed that the detection frame in the upper part det_dr corresponds to the detection result det_ur of a mushroom pleat image from a right bottom view of the mushroom stick, and it is assumed that the detection frame in the lower part det_dl corresponds to the detection result det_ul of the mushroom pleat image from a left bottom view of the mushroom stick; a list of targets to be picked in a mushroom cap image with a top view is determined, and the targets to be picked comprise the following four situations: \textcircled{1}. the mushroom cap belongs to a white category, and the mushroom pleat belongs to an un-open category; \textcircled{2}. the mushroom cap belongs to a white category, and the mushroom pleats belong to a slightly open category; \textcircled{3}. the mushroom cap belongs to a normal category, and the mushroom pleats belong to an un-open category; \textcircled{4}. the mushroom cap belongs to a normal category, and the mushroom pleats belong to a slightly open category;
Step 3: deploying the mushroom object detection model in a controller; and
Step 4: controlling, by the controller, a robot arm and an execution end to act to perform a picking task;
Step (1): driving, by the mushroom stick take-up device, the mushroom stick to move to a position close to the execution end of the mushroom picking device, controlling, by the controller, the mechanical arm to act, so that the mushroom identification depth camera reaches the shooting position above the mushroom stick, and acquiring, by the mushroom identification depth camera, the first depth camera and the second depth camera, RGB images and depth images of the mushroom stick, and transmitting the RGB images and the depth images to the controller;
Step (2): inputting the RGB images into the mushroom object detection model, and identifying the target to be picked through multi-view target matching, wherein the RGB color mode is a color standard in the industry and RGB represents red, green and blue, which is the fundamental color mode;
Step (3): obtaining, by the controller, three-dimensional coordinates of a center point of the mushroom cap of the target to be picked, thereafter, converting the three-dimensional coordinates of the center point of the mushroom cap into position information in a base coordinate system of the mechanical arm through coordinate conversion, guiding, by action of the mechanical arm, the execution end to move to the target to be picked, and picking mushroom targets to be picked on the mushroom stick by the execution end executing the picking action.

In one embodiment, in a process of the multi-view target matching, for each mushroom cap target det_up in the upper part det_dr, a detection frame list det_ups in a range slightly larger than the width of the mushroom cap target det_up in the x-axis direction is acquired in det_ur, thereafter, the detection frame with a minimum coordinate value in the y-axis direction is selected from det_ups, as the mushroom pleat target corresponding to the mushroom cap target det_up; for each mushroom cap target det_down in the lower part det_dl, a detection frame list det_downs in a range slightly larger than the width of the mushroom cap target det_down in the x-axis direction is acquired in det_ul, thereafter, the detection frame with a minimum coordinate value in the y-axis direction is selected from det_downs, as the mushroom pleat target corresponding to the mushroom cap target det_down.

In one embodiment, in Step (2) of the Step 1, the frame-extracted images are preliminarily screened by an image quality evaluation method, thereafter, the images containing incomplete mushroom sticks are manually checked and removed, and then image frames extracted in the first few seconds and the last few seconds of an original video are selected, and finally the mushroom object detection data set is obtained.

The present disclosure further provides a mushroom detection and grading method based on multi-view fusion, including the following steps:
Step 1: constructing a multi-view data set for training a mushroom object detection model;
Step (1): acquiring video data of a mushroom stick using a depth camera, wherein a depth camera is initially located directly above the mushroom stick with an overhead shot looking down, and after video shooting, is moved around a side of the mushroom stick at a constant speed and stops recording video data upon being moved to a lower left side of the mushroom stick and having mushroom pleats be shot upward, so as to complete acquisition of a first video data of the mushroom stick; thereafter, recording a second video data, wherein the depth camera is initially located directly above the mushroom stick with an overhead shot looking down, and after video shooting, is moved around a side of the mushroom stick at a constant speed and stops recording video data upon being moved to a lower right side of the mushroom stick and having mushroom pleats being shot upward, so as to complete acquisition of a second video data of the mushroom stick; and acquiring a plurality of videos for a plurality of mushroom sticks;
Step (2): obtaining still images of mushrooms, includes: obtaining frame-extracted images by extracting frames from each video stream of the plurality of mushroom sticks, and screening a set of a large number of mushroom object detection data from the frame-extracted images, wherein the mushroom object detection data set includes mushroom cap images with a top view and mushroom pleat images with a bottom view; and
Step (3): labeling the data set according to six quality categories including white, normal, abnormal, un-open, slightly open and fully open; and
Step 2: training the mushroom object detection model based on a YOLOv8 deep learning algorithm;
Step (1): training the model;
using a YOLOv8 object detection model as the mushroom object detection model, and training the mushroom object detection model by using the mushroom object detection data set constructed in the Step 1; and
Step (2): performing multi-view target matching; wherein the three images of the mushroom stick shot by the mushroom identification depth camera, the first depth camera and the second depth camera are combined into a batch, the batch is input into the mushroom object detection model to obtain the mushroom detection results from three views (i.e. a top view, a right bottom view and a left bottom view): det_d, det_ur and det_ul; the mushroom cap is matched with the mushroom pleats using a rule-based method; first, a detection frame in det_d is divided into an upper part det_dr and a lower part det_dl with a middle line of a picture in a width direction as a dividing line, it is assumed that the detection frame in the upper part det_dr corresponds to the detection result det_ur of a mushroom pleat image from a right bottom view of the mushroom stick, and it is assumed that the detection frame in the lower part det_dl corresponds to the detection result det_ul of the mushroom pleat image from a left bottom view of the mushroom stick; a list of targets to be picked in a mushroom cap image with a top view is determined, and the targets to be picked comprise the following four situations: \textcircled{1}. the mushroom cap belongs to a white category, and the mushroom pleats belong to an un-open category; \textcircled{2}. the mushroom cap belongs to a white category, and the mushroom pleats belong to a slightly open category; \textcircled{3}. the mushroom cap belongs to a normal category, and the mushroom pleats belong to an un-open category; \textcircled{4}. the mushroom cap belongs to a normal category, and the mushroom pleats belong to a slightly open category;
In one embodiment, in Step (2) of the Step 1, the frame-extracted images are preliminarily screened by an image quality evaluation method and are subjected to manual inspection to the images containing incomplete mushroom sticks, and then image frames extracted in the first few seconds and the last few seconds of an original video are selected from inspected images, and finally the mushroom object detection data set is obtained.

In one embodiment, in the Step 2, the mushroom object detection model is formed by pruning a detection head of a P3 layer and an entire P5 layer, and retaining only the output of a detection head of a P4 layer based on a basic structure of the YOLOv8 object detection model

The present disclosure further provides a non-transitory storage medium on which a computer program is stored, wherein the computer program, when being executed by a processor, implements each step of the method describe above.

The present disclosure has the following beneficial effect: (1) the degree of automation is high, the mushroom sticks are automatically taken out of the narrow space of each layer of the mushroom rack, the mushrooms that have grown mature on the mushroom sticks are automatically picked, and the mushroom sticks are put back into the mushroom rack automatically; (2) the picking efficiency is high; (3) the mushroom cap and the mushroom stick will not be damaged during the picking operation; (4) the action process of the robot is reliable and stable; (5) the execution end is small in volume and flexible and reliable in action; (6) the mature mushrooms on the mushroom sticks are accurately and visually identified for automatic picking, and the immature mushrooms are reserved to continue growing on the mushroom stick; (7) multi-view target matching associates the mushroom cap of the same target with the category information in the detection result of the mushroom pleats, so as to comprehensively judge whether the mushroom meets the picking requirements; (8) mushroom targets to be picked are divided in terms of the quality grade, so as to carry out graded picking.

Further features and aspects of the present disclosure will be clearly described in the following description of specific embodiments with reference to the attached drawings.

### BRIEF DESCRIPTION OF THE DRAWINGS

FIG. 1 is an axonometric view of a factory mushroom picking robot.

FIG. 2 is a front view of the factory mushroom picking robot shown in FIG. 1.

FIG. 3 is a left view of the factory mushroom picking robot shown in FIG. 1.

FIG. 4 is a right view of the factory mushroom picking robot shown in FIG. 1.

FIG. 5 is a top view of the factory mushroom picking robot shown in FIG. 1.

FIG. 6 is a bottom view of the factory mushroom picking robot shown in FIG. 1.

FIG. 7 is an axonometric view of the factory mushroom picking robot from another view.

FIG. 8 is an axonometric view of the factory mushroom picking robot from another view.

FIG. 9 is an axonometric view of the factory mushroom picking robot from another view.

FIG. 10 is an axonometric view of the factory mushroom picking robot from another view.

FIG. 11 is an axonometric view of a mushroom stick take-up device.

FIG. 12 is a front view of the mushroom stick take-up device shown in FIG. 11.

FIG. 13 is a top view of the mushroom stick take-up device shown in FIG. 11.

FIG. 14 is a bottom view of the mushroom stick take-up device shown in FIG. 11.

FIG. 15 is a right view of the mushroom stick take-up device shown in FIG. 11.

FIG. 16 is an axonometric view of a mushroom stick take-up device.

FIG. 17 is an axonometric view of a mushroom stick take-up device.

FIG. 18 is a schematic structural diagram of a mushroom stick take-up device, in which an L-shaped connecting plate I and a slider I are connected with a nut seat I, and an L-shaped connecting plate II and a slider II are connected with a nut seat II.

FIG. 19 is a partial enlarged view of a connection between an execution end and a mechanical arm of the mushroom picking device in FIG. 7.

FIG. 20 is an axonometric view of an execution end.

FIG. 21 is a front view of the execution end shown in FIG. 20.

FIG. 22 is a top view of the execution end shown in FIG. 20.

FIG. 23 is a bottom view of the execution end shown in FIG. 20.

FIG. 24 is an axonometric view of the execution end shown in FIG. 20 from another view.

FIG. 25 is an axonometric view of the execution end shown in FIG. 20 from another view.

FIG. 26 is a schematic diagram of a state that two clamping blocks of an execution end clamp a mushroom stipe of a mushroom.

FIG. 27 is a schematic diagram of a state that two clamping blocks of an execution end clamp a mushroom stipe of a mushroom.

FIG. 28 is a schematic diagram of a state that a factory mushroom picking robot is located near a mushroom rack and takes out mushroom sticks placed on the mushroom rack.

FIG. 29 is a side view of FIG. 28.

FIG. 30 is a partial enlarged view of a part of the structure in FIG. 28.

FIG. 31 is a schematic diagram of a state that a mushroom stick take-up device descends to a position close to an execution end of the mushroom picking device in the structure shown in FIG. 1.

FIG. 32 is a front view of the structure shown in FIG. 31.

FIG. 33 is a side view of the structure shown in FIG. 31.

FIG. 34 is a top view of the structure shown in FIG. 31.

FIG. 35 is a schematic structural diagram of a mushroom stick near the execution end of the mushroom picking device in FIG. 31.

FIG. 36 is a schematic diagram of a process in which a depth camera shoots starting from a top view directly above the mushroom stick, while being held by an operator to move around a side of the mushroom stick at a constant speed, and stops recording until being moved to a lower side of the mushroom stick at which mushroom pleats are shot upward, and images are obtained by extracting frames from the shot video.

FIG. 37 is an example of six quality categories of mushrooms.

FIG. 38 is a schematic diagram of positions where a mushroom identification depth camera, a first depth camera and a second depth camera acquire mushroom stick images, as well as an image acquired from a top view and an image acquired from a bottom view.

FIG. 39 is a schematic diagram of a target matching process.

FIG. 40 is an architecture diagram of a mushroom object detection model.

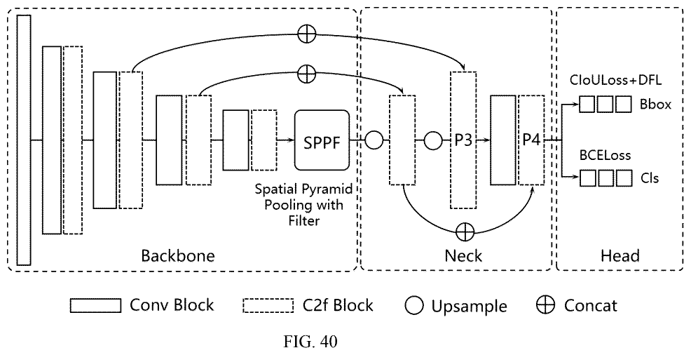

### DESCRIPTION OF REFERENCE NUMBERS IN THE FIGURES

100. Chassis; 200. Lifting device; 201. First fixed plate; 202. Second fixed plate; 203. First electric cylinder; 204. Second electric cylinder; 205. Support plate; 300. Mushroom stick take-up device; 301. First base; 302. First guide rail component; 303. Second guide rail component; 304. Y-axis-direction screw rod; 305. First driving motor; 306. First synchronous belt wheel; 307. Second synchronous belt wheel; 308. First synchronous belt; 309. Sliding plate; 310. Second base; 311. Third guide rail component; 312. X-axis-direction bidirectional screw rod; 313. Slider I; 314. Slider II; 315. L-shaped connecting plate I; 316. L-shaped connecting plate II; 317. Clamping rod I; 317-1. Inclined surface; 318. Clamping rod II; 318-1. Inclined surface; 319. Nut seat I; 320. Nut seat II; 321. Second driving motor; 322. Third synchronous belt wheel; 323. Fourth synchronous belt wheel; 324. Second synchronous belt; 400. Mushroom picking device; 401. Lifting mechanism; 402. Mechanical arm; 403. Executive end; 403-1. Support frame; 403-2. Clamping driving motor; 403-3. Screw rod; 403-4. Screw rod nut; 403-5. Connecting block; 403-6. First connecting rod; 403-7. First V-shaped connecting rod; 403-8. Second connecting rod; 403-9. Second V-shaped connecting rod; 403-10. First clamping block; 403-10-1. Arc-shaped groove; 403-11. Second clamping block; 403-11-1. Arc-shaped groove; 403-12. Mushroom identification depth camera; 500. First depth camera; 600. Second depth camera; 1. Collecting basket; 2. Mushroom stick; 3. Mushroom; 3-1. Mushroom stipe; 3-2. Mushroom cap; 4. Mushroom rack.

### DETAILED DESCRIPTION OF THE EMBODIMENTS

With reference to the accompanied drawings, the present disclosure will be further described in detail with specific embodiments.

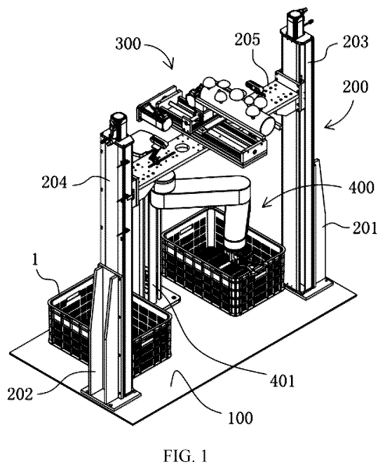

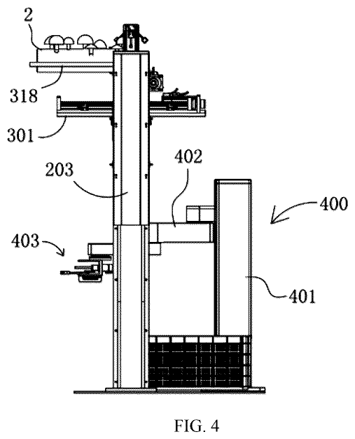

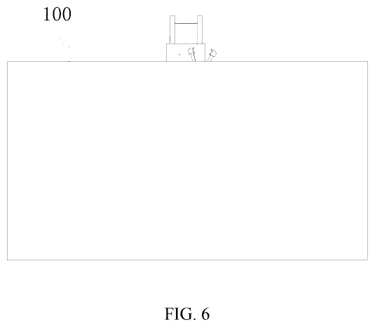

As shown in FIGS. 1-10, the factory mushroom picking robot includes a chassis 100, a lifting device 200, a mushroom stick take-up device 300 and a mushroom picking device 400. The lifting device 200 is installed on the chassis 100. The mushroom stick take-up device 300 is connected with the lifting device 200. The mushroom picking device 400 is installed on the chassis 100. The lifting device 200 can drive the mushroom stick take-up device 300 to move in the vertical direction. After taking up a mushroom stick from the mushroom rack, the mushroom stick take-up device 300 is driven by the lifting device 200 to move downward to a position close to the mushroom picking device 400, and then the mushroom picking device 400 acts to pick the mushrooms from the mushroom stick. The picked mushrooms are put into the collecting baskets 1 (two collecting baskets 1 are shown on the chassis 100 in the figures).

The lifting device 200 includes a first fixed plate 201, a second fixed plate 202, a first electric cylinder 203, a second electric cylinder 204, and a support plate 205. The first electric cylinder 203 is fixedly connected with the first fixed plate 201, the second electric cylinder 204 is fixedly connected with the second fixed plate 202, and the first electric cylinder 203 and the second electric cylinder 204 are vertically arranged side by side. The first electric cylinder 203 is provided with a first slider, the second electric cylinder 204 is provided with a second slider, and one end of the support plate 205 is connected with the first slider on the first electric cylinder 203, and the other end of the support plate 205 is connected with the second slider on the second electric cylinder 204.

The first fixed plate 201 is fixedly connected with the chassis 100, and the second fixed plate 202 is fixedly connected with the chassis 100, thereby fixing the lifting device 200 on the chassis 100. When the first electric cylinder 203 and the second electric cylinder 204 act at the same time, the first slider and the second slider drive the support plate 205 to move up or down, so that the support plate 205 can be lifted up and down in the vertical direction.

The mushroom stick take-up device 300 is fixedly installed on the support plate 205, and the support plate 205 moves up and down in the vertical direction to drive the mushroom stick take-up device 300 to move up and down in the vertical direction.

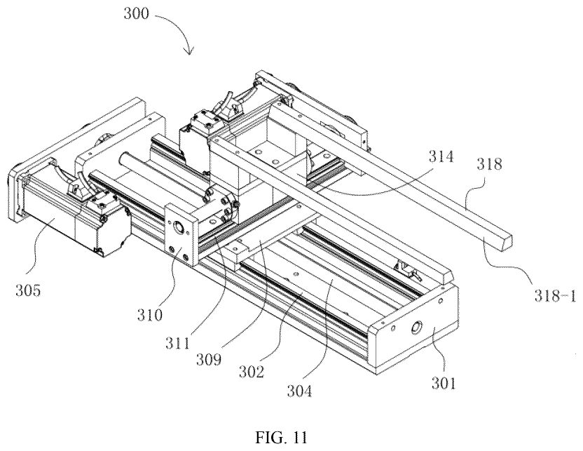

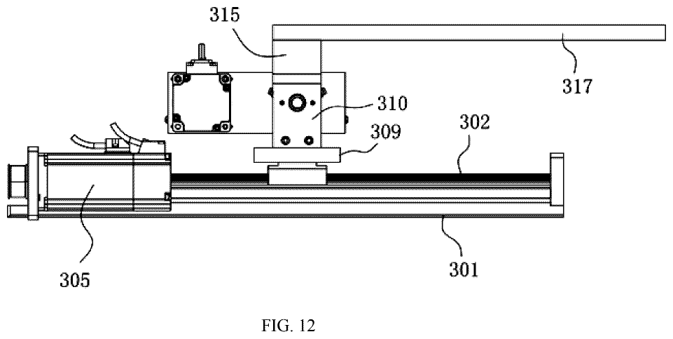

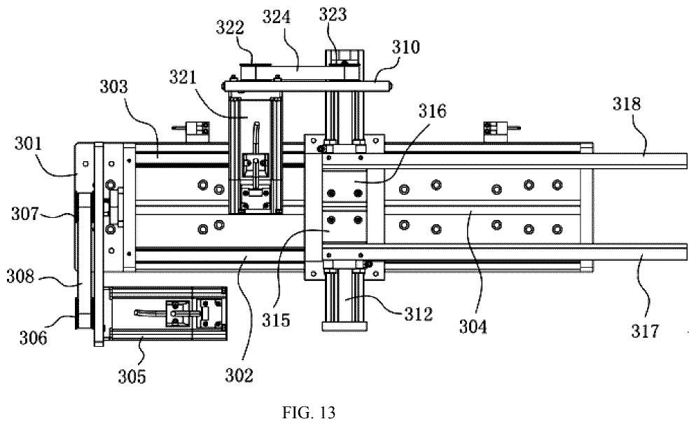

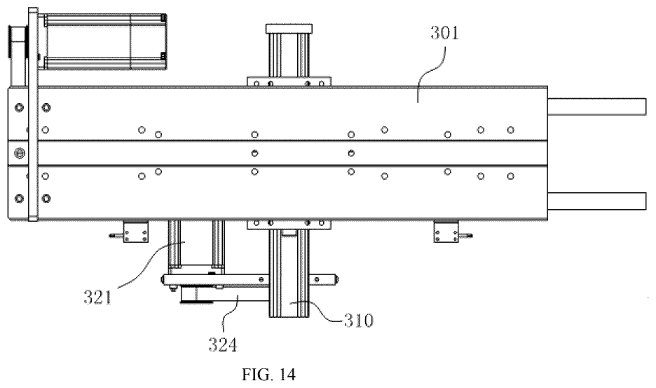

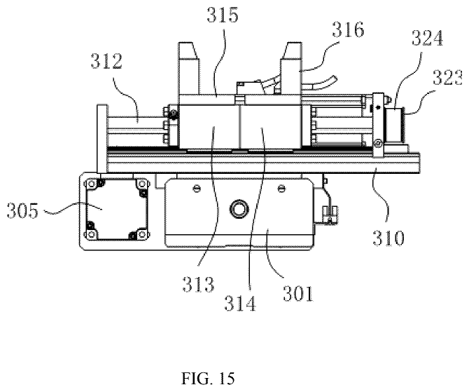

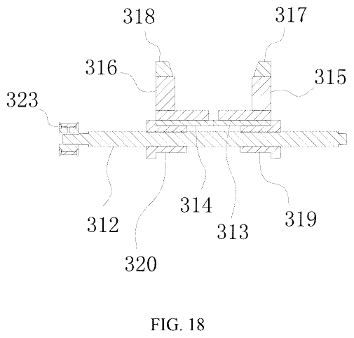

As shown in FIGS. 11-18, the mushroom stick take-up device 300 includes a first base 301, a first guide rail component 302, a second guide rail component 303, a Y-axis-direction screw rod 304, a nut, a first driving motor 305, a first synchronous belt wheel 306, a second synchronous belt wheel 307, a first synchronous belt 308, a sliding plate 309, a second base 310, a third guide rail component 311, an X-axis-direction bidirectional screw rod 312, a slider I 313, a slider II 314, an L-shaped connecting plate I 315, an L-shaped connecting plate II 316, a clamping rod I 317, a clamping rod II 38, a nut seat I 319, a nut seat II 320, a second driving motor 321, a third synchronous belt wheel 322, a fourth synchronous belt wheel 323, and a second synchronous belt 324. The first guide rail component 302 and the second guide rail component 303 are fixedly installed on the first base 301, respectively. The first guide rail component 302 and the second guide rail component 303 are arranged side by side. A front end of the Y-axis-direction screw rod 304 is rotatably connected with a front portion of the first base 301 through a bearing. A rear end of the Y-axis-direction screw rod 304 is rotatably connected with a rear portion of the first base 301 through a bearing. The Y-axis-direction screw rod 304 is located between the first guide rail component 302 and the second guide rail component 303. The first driving motor 305 is fixedly installed on a rear portion of the first base 301. The first synchronous belt wheel 306 is connected with an output shaft of the first driving motor 305. The second synchronous belt wheel 307 is connected with a rear end of the Y-axis-direction screw rod 304. The first synchronous belt 308 is connected between the first synchronous belt wheel 306 and the second synchronous belt wheel 307. The nut is engaged with the Y-axis-direction screw rod 304. The sliding plate 309 is fixedly connected with the nut. One side of the sliding plate 309 is fixedly connected with the slider on the first guide rail component 302, and the other side of the sliding plate 309 is fixedly connected with the slider on the second guide rail component 303. The second base 310 is fixedly installed on the sliding plate 309. The third guide rail component 311 is fixedly installed on the second base 310. A left end of the X-axis-direction bidirectional screw rod 312 is rotatably connected with a left portion of the second base 310 through a bearing. A right end of the X-axis-direction bidirectional screw rod 312 is rotatably connected with a right portion of the second base 310 through a bearing. The nut seat I 319 and the nut seat II 320 are connected with the X-axis-direction bidirectional screw rod 312. The slider I 313 is fixedly connected with the nut seat I 319, and the slider II 314 is fixedly connected with the nut seat II 320. The L-shaped connecting plate I 315 is fixedly connected with the slider I 313, and the L-shaped connecting plate II 316 is fixedly connected with the slider II 314. The second driving motor 321 is fixedly connected with a left portion of the second base 310. The third synchronous belt wheel 322 is connected with an output shaft of the second driving motor 321. The fourth synchronous belt wheel 323 is connected with a left end of the X-axis-direction bidirectional screw rod 312. The second synchronous belt 324 is connected between the third synchronous belt wheel 322 and the fourth synchronous belt wheel 323. A rear end of the clamping rod I 317 is fixedly connected with the L-shaped connecting plate I 315. A rear end of the clamping rod II 318 is fixedly connected with the L-shaped connecting plate II 316.

The main working process of the mushroom stick take-up device 300 is as follows. When the second driving motor 321 works, the transmission of the third synchronous belt wheel 322, the second synchronous belt 324 and the fourth synchronous belt wheel 323 drives the X-axis-direction bidirectional screw rod 312 to rotate. The X-axis-direction bidirectional screw rod 312 drives the nut seat I 319 and the nut seat II 320 to move closer to each other or move away from each other in the X-axis direction, so as to drive the slider I 313 and the slider II 314 to move close to each other or move away from each other. Thereafter, the L-shaped connecting plate I 315 and the L-shaped connecting plate II 316 move close to each other or move away from each other, so that the clamping rod I 317 and the clamping rod II 318 move close to each other or move away from each other in the X-axis direction. When the first driving motor 305 works, the transmission of the first synchronous belt wheel 306, the first synchronous belt 308 and the second synchronous belt wheel 307 drives the Y-axis-direction screw rod 304 to rotate. The nut engaged with the Y-axis-direction screw rod 304 drives the sliding plate 309 to move forward or backward along the Y-axis direction. The sliding plate 309 drives the second base 310 to move forward or backward along the Y-axis direction, and finally drives the clamping rod I 317 and the clamping rod II 318 to move forward or backward as a whole. The process of taking out and putting back the mushroom sticks by the mushroom stick take-up device is stable and reliable without damaging the mushroom sticks. As a power source, a motor drives the two clamping rods to act such that the moving precision of the clamping rods is high, which is suitable for mushroom sticks of various sizes.

The first base 301 of the mushroom stick take-up device 300 is fixedly installed on the support plate 205, and the support plate 205 is lifted up and down in the vertical direction to drive the whole mushroom stick take-up device 300 to move up or down in the vertical direction.

The mushroom picking device 400 includes a lifting mechanism 401, a mechanical arm 402, and an execution end 403. The lifting mechanism 401 is fixedly installed on the chassis 100. The mechanical arm 402 is connected with the lifting mechanism 401. The execution end 403 is connected with a free end of the mechanical arm 402. The lifting mechanism 401 is located between the first electric cylinder 203 and the second electric cylinder 204 of the lifting device 200, that is, the mushroom picking device 400 is located between the first electric cylinder 203 and the second electric cylinder 204. The lifting mechanism 401 can drive the whole mechanical arm 402 to move in the vertical direction and adjust the position of the mechanical arm 402, thus adjusting the position of the execution end 403.

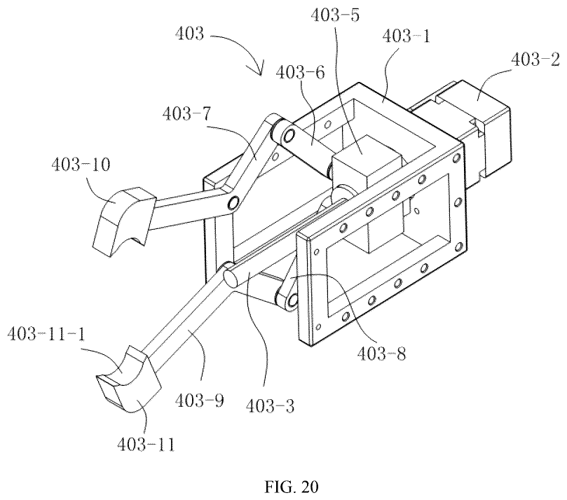

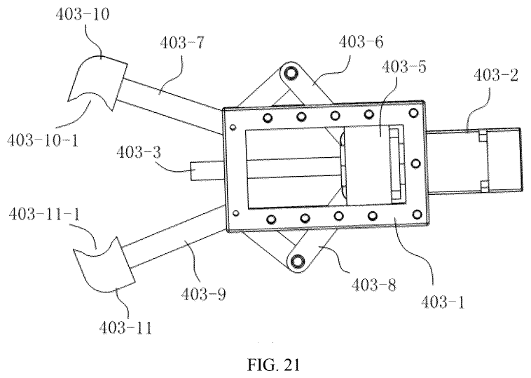

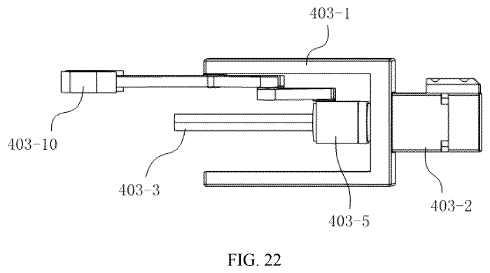

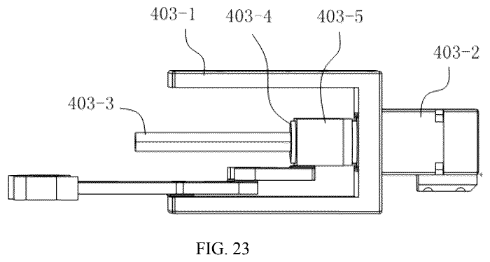

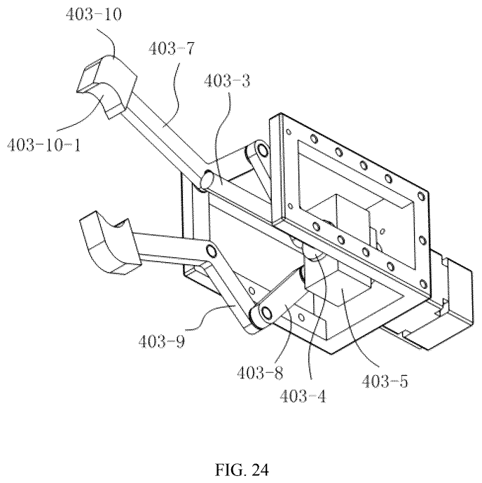

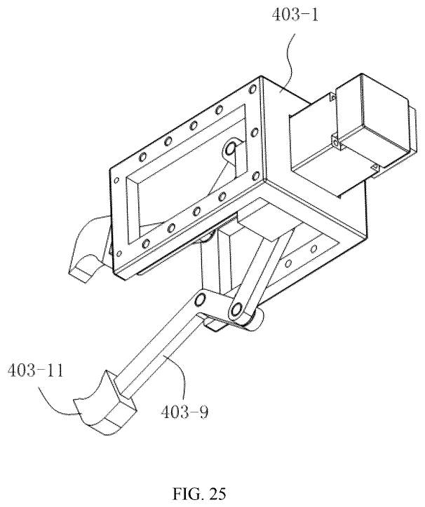

As shown in FIGS. 20-25, the execution end 403 includes a support frame 403-1, a clamping driving motor 403-2, a screw rod 403-3, a screw rod nut 403-4, a connecting block 403-5, a first connecting rod 403-6, a first V-shaped connecting rod 403-7, a second connecting rod 403-8, a second V-shaped connecting rod 403-9, a first clamping block 403-10 and a second clamping block 403-11. The clamping driving motor 403-2 is fixedly installed on the support frame 403-1. The screw rod 403-3 is fixedly connected with an output shaft of the clamping driving motor 403-2. The screw rod nut 403-4 is engaged with the screw rod 403-3. The connecting block 403-5 is fixedly connected with the screw rod nut 403-4. A rear end of the first connecting rod 403-6 is rotatably connected with the connecting block 403-5. A front end of the first connecting rod 403-6 is rotatably connected with a rear end of the first V-shaped connecting rod 403-7. A middle portion of the first V-shaped connecting rod 403-7 is rotatably connected with the support frame 403-1. A rear end of the second connecting rod 403-8 is rotatably connected with the connecting block 403-5. A front end of the second connecting rod 403-8 is rotatably connected with a rear end of the second V-shaped connecting rod 403-9. A middle portion of the second V-shaped connecting rod 403-9 is rotatably connected with the support frame 403-1. The first connecting rod 403-6 and the second connecting rod 403-8 are arranged symmetrically to each other. The first V-shaped connecting rod 403-7 and the second V-shaped connecting rod 403-9 are arranged symmetrically to each other. The first clamping block 403-10 is fixedly connected with a front end of the first V-shaped connecting rod 403-7. The second clamping block 403-11 is fixedly connected with a front end of the second V-shaped connecting rod 403-9. The first clamping block 403-10 is provided with an arc-shaped groove 403-10-1. The second clamping block 403-11 is provided with an arc-shaped groove 403-11-1. When the clamping driving motor 403-2 works, the clamping driving motor can drive the screw rod 403-3 to rotate, and the screw rod nut 403-4 moves along with the rotation. The screw rod nut 403-4 drives the connecting block 403-5 to translate forward or backward. When the connecting block 403-5 moves forward, the first clamping block 403-10 and the second clamping block 403-11 can get close to each other, so as to be closed. When the connecting block 403-5 moves backward, the first clamping block 403-10 and the second clamping block 403-11 can be separated from each other, so as to be opened (FIG. 21 shows the open state).

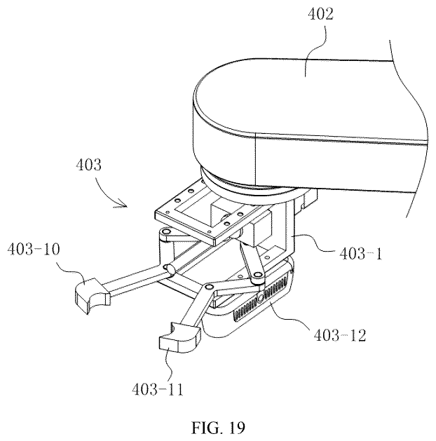

Referring to FIG. 19, the support frame 403-1 is fixedly installed at a free end of the mechanical arm 402 by a screw. The first clamping block 403-10 and the second clamping block 403-11 are located on the same horizontal plane.

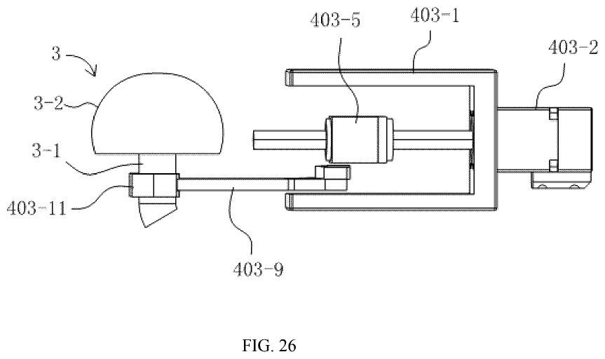

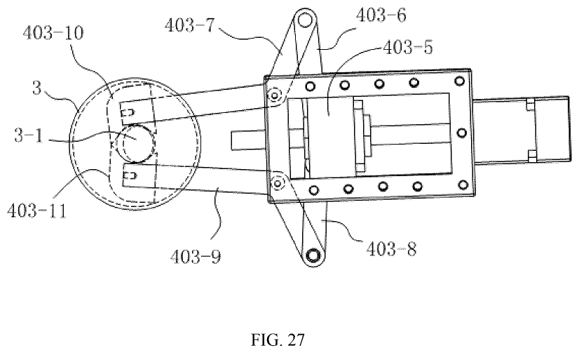

Referring to FIG. 26 and FIG. 27, when the connecting block 403-5 moves forward, the first clamping block 403-10 and the second clamping block 403-11 get close to each other, so as to clamp the mushroom stipe 3-1 of the mushroom 3 growing on the mushroom stick. Specifically, the arc-shaped groove 403-10-1 and the arc-shaped groove 403-11-1 clamp the mushroom stipe 3-1. The clamping action will not damage the mushroom cap or the mushroom stick. The picking process is reliable and stable. The execution end 40 is small in size, flexible and reliable in action, and able to accurately adjust the opening degree of the two clamping blocks. As a power source, a motor drives the screw rod, making the moving precision of the two clamping blocks high.

It should be noted that the specific structure of the mechanical arm 402 shown in FIGS. 1-10 is only an example. The specific structure of the mechanical arm can also be any other structure that realizes the function of the mechanical arm and drives the execution end 403 to reach any desired position in space.

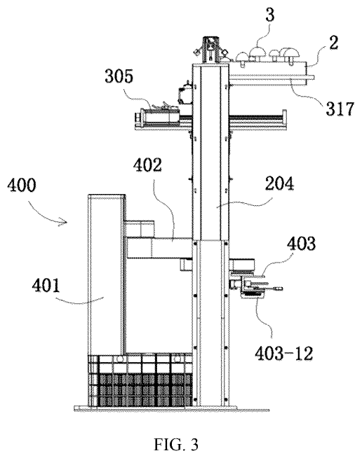

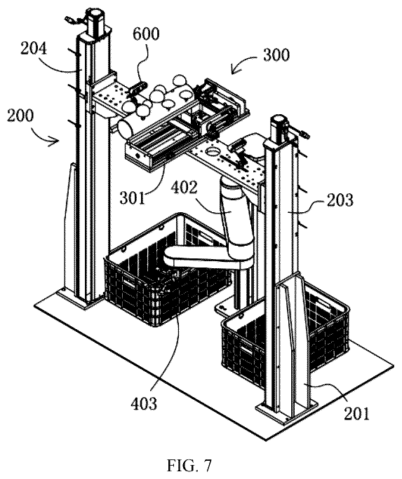

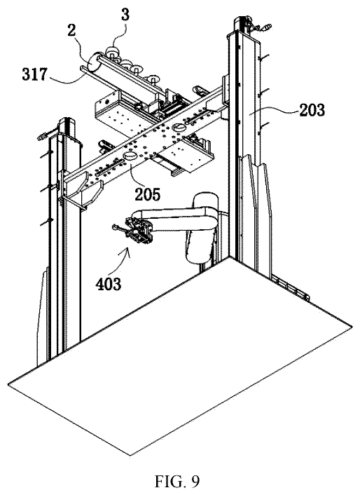

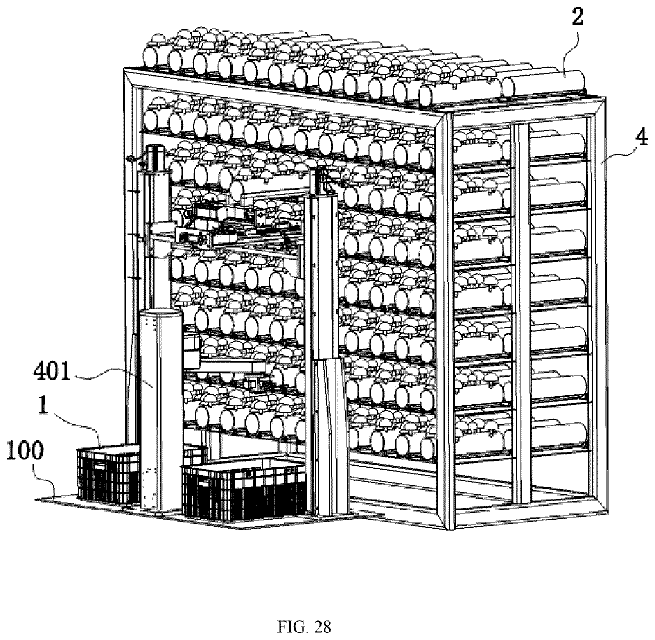

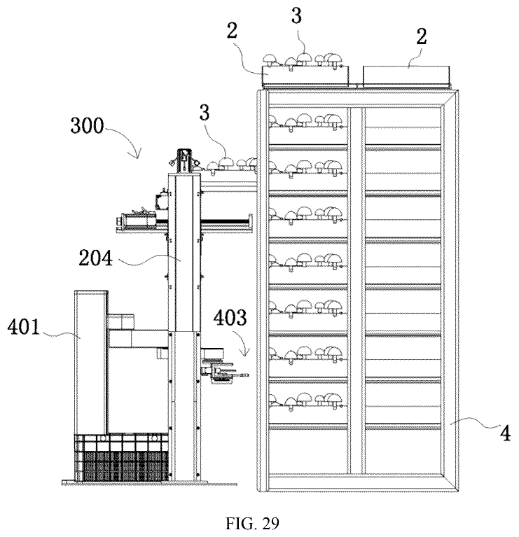

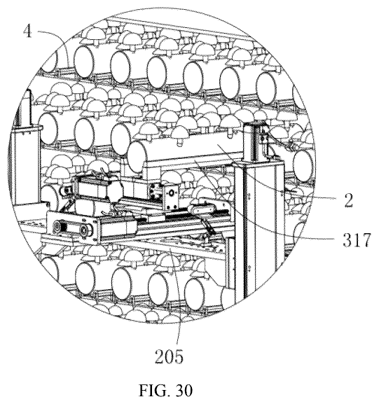

As shown in FIGS. 28-30, two rows of mushroom sticks are placed on each layer of the mushroom rack 4. There are 12 mushroom sticks in each row. There is a certain distance between two adjacent mushroom sticks. The factory mushroom picking robot is moved near the mushroom rack 4. The mushroom stick take-up device 300 is facing a mushroom stick in a certain layer on the mushroom rack 4 directly and carrying out the take-up operation. The specific process is as follows. Firstly, the second driving motor 321 of the mushroom stick take-up device 300 works, so that the slider I 313 and the slider II 314 move away from each other, and therefore, the clamping rod I 317 and the clamping rod II 318 move away from each other in the X-axis direction. Secondly, the first driving motor 305 works to drive the second base 310 to move forward along the Y-axis direction, so that the clamping rod I 317 and the clamping rod II 318 move forward along the Y-axis direction (facing the target mushroom stick). The clamping rod I 317 and the clamping rod II 318 extend into the space at both sides of the target mushroom stick (that is, the target mushroom stick is located between the clamping rod I 317 and the clamping rod II 318, and the two clamping rods are not in contact with both sides of the mushroom stick at this time). Thereafter, the second driving motor 321 works, so that the clamping rod I 317 and the clamping rod II 318 get close to each other in the X-axis direction, and therefore, the clamping rod I 317 and the clamping rod II 318 are clamped at both sides of the target mushroom stick, thus clamping the target mushroom stick. Subsequently, the first driving motor 305 works to drive the second base 310 to move backward along the Y-axis direction. The clamping rod I 317 and the clamping rod II 318 move backward with the target mushroom stick, so as to take the target mushroom stick 2 out of the mushroom rack (refer to the state shown in FIG. 30 and FIG. 29). The state of the taken mushroom stick 2 is shown in FIG. 1, FIG. 3, FIG. 7 and FIG. 9.

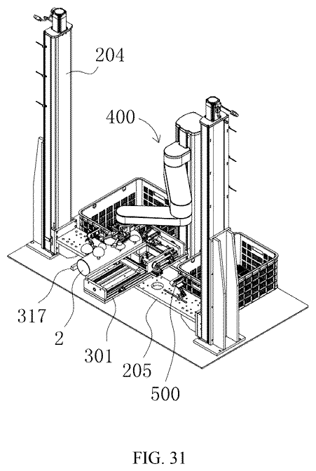

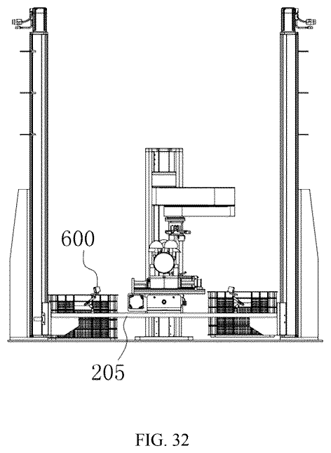

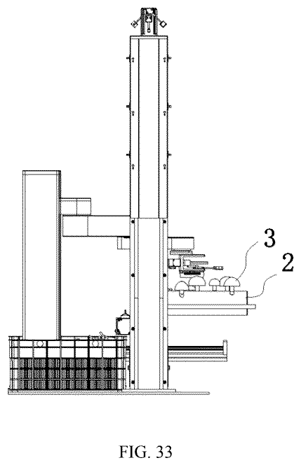

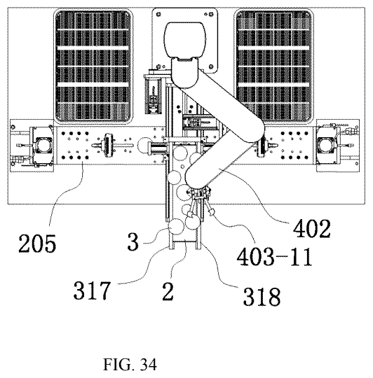

Next, the lifting device 200 acts to drive the mushroom stick take-up device 300 to move downward. The mushroom stick take-up device 300 drives the mushroom stick 2 to move downward to a position close to the execution end 403 of the mushroom picking device 400, as shown in FIGS. 31-35. A plurality of mushrooms 3 grown on the mushroom stick 2 are within the operation range of the mushroom picking device 400.

Next, the mushroom picking device 400 picks the mushroom 3 on the mushroom stick 2. Specifically, the mechanical arm 402 acts to move the execution end 403 to the mushroom 3. The first clamping block 403-10 and the second clamping block 403-11 of the execution end 403 are located at both sides of the mushroom 3 in an open state, and then the first clamping block 403-10 and the second clamping block 403-11 get close to each other to clamp the mushroom stipe of the mushroom 3 (the clamping state is shown in FIG. 26 and FIG. 27). Thereafter, the mechanical arm 402 drives the execution end 403 as a whole to move for a certain distance to pick the mushroom 3 from the mushroom stick 2. It can be seen that the execution end 403 will not touch the mushroom cap when clamping the mushroom, so that the mushroom cap will not be damaged. In addition, the execution end will not touch the mushroom stick 2 and will not damage the mushroom stick. When clamping a mature mushroom, the execution end will not touch other mushrooms nearby, and will not damage other mushrooms nearby.

Next, the mechanical arm 402 acts to move the execution end 403 above the collecting basket 1, and then the first clamping block 403-10 and the second clamping block 403-11 of the execution end 403 move away from each other to an open state, so that the clamped mushrooms 3 are released and fall into the collecting basket 1.

According to the above picking method, the mushroom picking device 400 picks other mushrooms on the mushroom stick 2 and puts the mushrooms into the collecting basket 1. After all the mushrooms on the mushroom stick 2 are picked, the mushroom stick is put back to the original position or other positions on the mushroom rack 4. The lifting device 200 drives the mushroom stick take-up device 300 to move upward. The mushroom stick take-up device 300 drives the processed mushroom stick to move to the original position or other positions of the mushroom rack 4. Thereafter, the first driving motor 305 works to drive the second base 310 to move forward in the Y-axis direction, thereby further making the clamping rod I 317 and the clamping rod II 318 with the processed mushroom stick move forward along the Y-axis direction. The processed mushroom stick is moved to a corresponding position on the mushroom rack. Subsequently, the clamping rod I 317 and the clamping rod II 318 of the mushroom stick take-up device 300 move away from each other, so that the clamping force applied to both sides of the processed mushroom stick disappears, and the processed mushroom sticks are placed on the mushroom rack. The first driving motor 305 immediately works to drive the clamping rod I 317 and the clamping rod II 318 move backward.

Next, the robot continues to pick other mushroom sticks on the mushroom rack 4.

It can be seen that the above picking process is high in degree of automation and high in picking efficiency. The execution end 403 is small in size and flexible and reliable in action. The execution end 403 can be driven by the mechanical arm 402 to reach any position in the space, so as to clamp the mushroom stalk of the mushroom target.

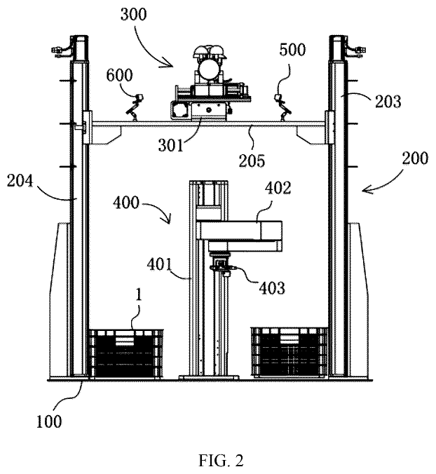

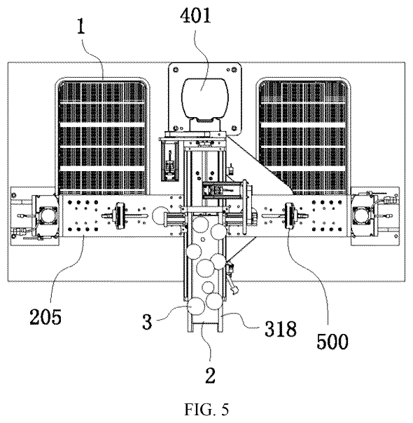

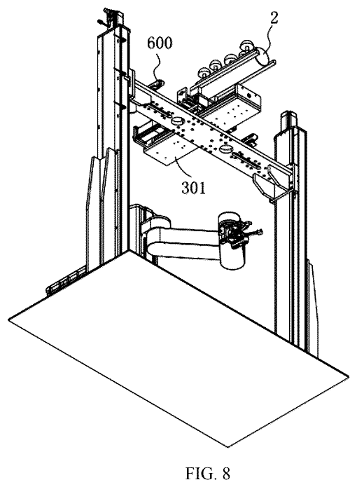

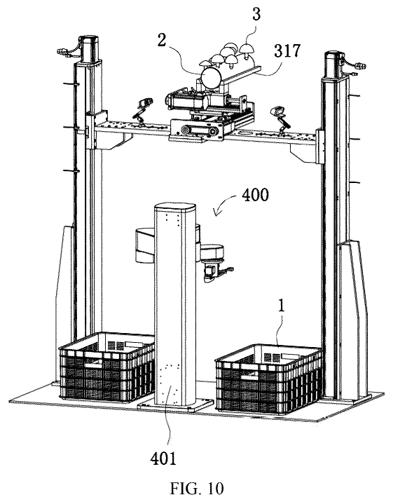

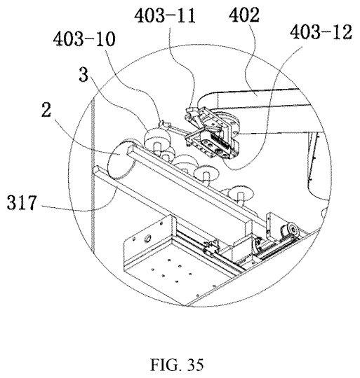

It should be noted that the mushroom identification depth camera 403-12 can be installed on the execution end 403. As shown in FIG. 35, FIG. 19 and FIG. 3, the mushroom identification depth camera 403-12 is fixedly connected with the support frame 403-1. The mushroom identification depth camera 403-12 acquires an image of the mushroom stick and transmits the image to the controller. The controller identifies the mushroom on the mushroom stick through machine vision technology and controls the action of the mechanical arm 402 to move the execution end 403 to the mushroom to be picked, so as to move the execution end to the mushroom to be picked more accurately. The mushroom stipe is clamped by two clamping blocks more accurately, so as to pick the mushroom target. In order to achieve further optimization and improvement, another two depth cameras (three cameras in total) are provided to identify the target mushroom to be picked on the mushroom stick. As shown in FIG. 2, FIG. 5, FIG. 7, FIG. 8 and FIG. 10, the two depth cameras are installed on the support plate 205 through the adjustable brackets. The first adjustable bracket is connected with the support plate 205. The first depth camera 500 is connected with the first adjustable bracket (the position and the view of the first depth camera 500 can be adjusted through the first adjustable bracket). The second adjustable bracket is connected with the support plate 205. The second depth camera 600 is connected with the second adjustable bracket (the position and the view of the second depth camera 600 can be adjusted through the second adjustable bracket). The first depth camera 500 can specifically use a realsense D435 depth camera, and the second depth camera 600 can specifically use a realsense D435 depth camera. The specific identification and control method is as follows.

The picking method using the mushroom detection and grading method based on multi-view fusion mainly includes the following steps.

Step 1: a multi-view data set is constructed for training a mushroom object detection model.

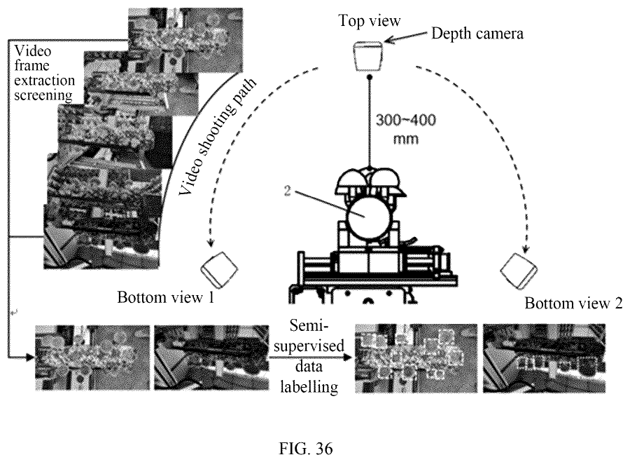

Step (1): video data of mushroom sticks are acquired. In a mushroom planting factory, video stream data is acquired using the RGB sensor of an Intel RealSense D435 depth camera. The resolution of the Intel RealSense D435 depth camera is adjusted to 1920*1080, and the frame rate is set as 60 fps. Referring to FIG. 36, the camera imaging plane keeps a distance of 300 to 400 mm away from the surface of the mushroom growing on the mushroom stick, so that the width direction of the image frame is consistent with the height direction of the mushroom stick cylinder, ensuring that the whole mushroom stick on which mushrooms grow can be included in the field of vision. When the depth camera is located directly above the mushroom stick as an initial position and shoots the mushroom top of the mushrooms on the mushroom stick downward with a top view, and after video shooting, the depth camera is held by hands to be moved around a side of the mushroom stick at a constant speed (i.e. moving in the direction of the dotted arrow in FIG. 36), and the position and the size of the mushroom stick are kept constant in the camera field of vision. When the depth camera moves to a lower left side of the mushroom stick and shoots mushroom pleats upward (i.e. the position with the bottom view 1 in FIG. 36), the video data stops recording, so as to complete the acquisition of a first video data of a mushroom stick. Thereafter, a second video data is recorded. When the depth camera is located directly above the mushroom stick as an initial position and shoots the mushroom top of the mushrooms on the mushroom stick downward with a top view, and after video shooting, the depth camera is held by hands to move around a side of the mushroom stick at a constant speed, and the position and the size of the mushroom stick are kept constant in the camera field of vision. When the depth camera moves to a lower right side of the mushroom stick and shoots the clear mushroom pleats upward (the position with the bottom view 2 in FIG. 36), the video data stops recording, so as to complete the acquisition of a second video data of the mushroom stick. In this embodiment, a total of 502 videos are acquired for 251 mushroom sticks, and the average duration of each video is 8s.

Step (2): still images of mushrooms are obtained from the video by extracting one frame per 30 frames. Frame extraction is carried out on each video stream of mushroom sticks to obtain frame-extracted images. It is easy to obtain blurred images when still images are extracted from a moving video. In order to screen and obtain a clear and high-quality image, the frame-extracted images are automatically screened by an image quality evaluation method. In this step, the image quality is defined as:

$$Q = α V + β S + γ C .$$

The image quality Q is the quality evaluation index without reference images, where α, β and γ are the coefficients of various terms.

The formula of the gradient variance V is:

$$V = \frac{1}{N} {\sum }_{x , y} [ {( {G}_{x} - {\overline{G}}_{x} )}^{2} + {( {G}_{y} - {\overline{G}}_{y} )}^{2} ] .$$

In the formula of the gradient variance V, G̅ₓ and G̅_{y} are the average values of gradients, and N is the total number of pixels in the image, x and y present horizontal and vertical directions of the image, respectively, Gx and Gy denote gradient components in horizontal and vertical directions, respectively.

The formula of the image sharpness S is:

$$S = {\sum }_{x , y} \vert {∇}^{2} I ( x , y ) \vert .$$

In the formula of the image sharpness S, ∇² is Laplace operator, and I(x, y) is the gray value of the image.

The formula of the contrast C is:

$$C = {\sum }_{δ} {δ ( i , j )}^{2} {P}_{δ} ( i , j ) .$$

In the formula of the contrast C, δ(i, j) is the gray value difference of the pixel at the position (i, j) by calculating, wherein (i, j) represents a coordinate position of a pixel; i represents the row index (i.e. vertical position) of the pixel, gradually increasing from top to bottom; j represents the column index (i.e. horizontal position) of the pixel, gradually increasing from left to right, and P_{δ}(i, j) is the distribution probability of 8.

Based on the above quality evaluation index Q without reference images, the frame-extracted images are preliminarily screened by a threshold method, thereafter, the images containing incomplete mushroom sticks are manually checked and removed to obtain clear and high-quality still images. On this basis, in order to obtain the image set of the mushroom cap and the mushroom pleats, the image frames extracted in the first 2 s and the last 2 s of an original video are selected, and finally a mushroom object detection data set with 820 available images is obtained. The mushroom object detection data set mainly includes a mushroom cap image with a top view and a mushroom pleat image with a bottom view. It should be noted that the first 2 s and the last 2 s of an original video are just examples, rather than limit the scope of protection.

In fact, the first few seconds and the last few seconds of the original video are feasible.

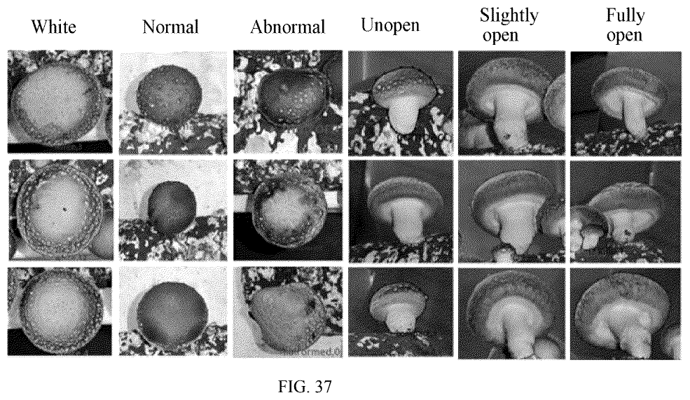

Step (3): the data is labelled. In order to realize supervised learning of a deep learning model, it is necessary to label the data set. In this embodiment, according to the actual production requirements of the mushroom planting factory, the acquired images are labeled according to six quality categories: white, normal, abnormal, un-open, slightly open and fully open. Refer to the example of labeling mushroom images shown in FIG. 37. The mushroom cap quality is white, normal and abnormal in a decreasing order, and the mushroom pleat quality is un-open, slightly open and fully open in a decreasing order. The specific process can be carried out by using a semi-supervised auxiliary labeling tool based on an SAM model. In the actual labeling process, a complete mask can be generated for the current target by clicking on the central area of a mushroom target on the image. The accurate mask label of the target can be obtained by clicking to increase or decrease the mask area, and then the corresponding quality category can be selected for the current target to finish labeling a mushroom. Since in this process, a json file containing all instance segmentation labels of mushroom targets is generated for each image, the labeled file needs to be converted into a txt file containing only rectangular box labels. Finally, the data set is divided into a training set with 700 images and a test set with 120 images.

The semi-supervised auxiliary labeling tool based on the SAM model can improve the manual labeling efficiency. The SAM model is short for Segment Anything Model.

Step 2: the mushroom object detection model is trained based on a YOLOv8 deep learning algorithm. You Only Look Once (YOLO) is a series of high-performance object detection algorithms commonly used in the field of computer vision, as known for good balance among speed, accuracy, and computing resource requirements. YOLOv8 represents the eighth major release in the series.

Step (1): the model is trained and verified.

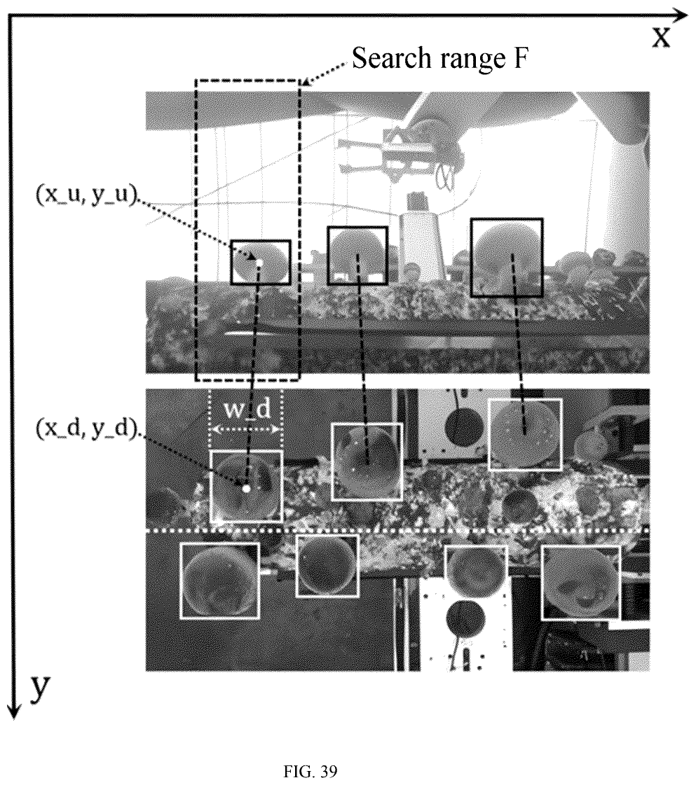

Taking into account the scale unity of the mushroom target in this task and the actual deployment scenario with limited computing resources, based on a basic structure of the YOLOv8 object detection model, this embodiment prunes a detection head of a P3 layer and an entire P5 layer, and retains only the output of a detection head of a P4 layer, thus forming a lightweight single-scale output model (that is, the mushroom object detection model), as shown in FIG. 39. Multi-scale prediction is used in the YOLOv8 model architecture in order to improve the detection accuracy of objects with different sizes such that the network performs inference and prediction at different feature map resolutions. Each of feature maps corresponds to a specific “scale”, which is commonly referred to as P3, P4 or P5. The single-scale output model reduces quantity of the model parameters and optimizes the model inference speed. The single-scale output model (the mushroom object detection model) is trained using the mushroom object detection data set constructed in the Step 1. In the training process, CIOULoss and BCELoss are used as loss functions in the branches of detection frame regression and category prediction, respectively. CIOULoss is an improved version of the Intersection over Union (IoU) Loss function, which not only takes into account the overlap region between the predicted and real frames, but also adds a penalty term for the centroid distance and the aspect ratio so as to accelerate the convergence and improve the localization accuracy. Binary Cross Entropy (BCE) Loss function is widely used in binary classification problems or multi-label classification tasks that require independent probability estimation for each category. In YOLOv8, it is mainly used to calculate the object existence or not (objectness score) and the confidence score of the category. An AdamW optimizer is used, which can improve the convergence speed of the model. Where AdamW is a parameter optimization algorithm for convolutional neural networks, which is one of the optimization algorithms based on gradient descent, integrating the advantages of the Adam optimizer with weight decay techniques. After sufficient training, the mean Average Precision (mAP) value of the single-scale output model (the mushroom object detection model) is up to 0.719 in the verification stage. At this time, the single-scale output model can be used for algorithm deployment. Where mAP is an evaluation metric widely used in the object detection field, which intends to determine ability of a model on correct classification and accurate position to the objects of different categories. Computation of mAP involves two key concepts such as precision and recall. The mAP is obtained by calculating the corresponding average precision (AP) for each category at different confidence thresholds and then taking the average of the APs of all categories. It should be noted that the mAP value is up to 0.719 during verification as an example, rather than limit the scope of protection of the technical scheme.

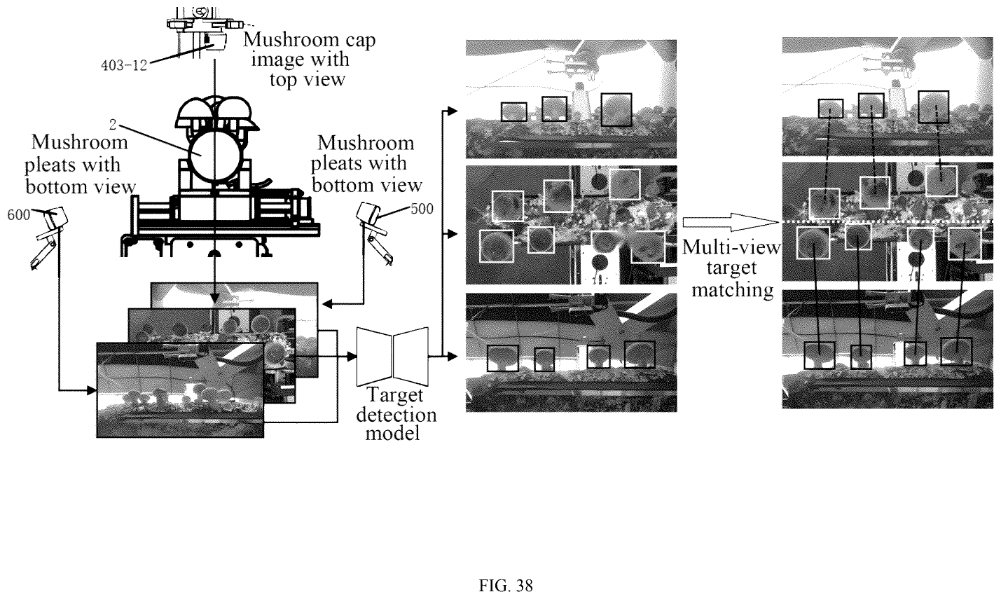

Step (2): multi-view target matching is carried out. Since the mushroom target quality grade is determined in combination with the visual information of the mushroom cap and the mushroom pleats, a mushroom identification depth camera 403-12 for shooting the mushroom cap with a top view, and a first depth camera 500 and a second depth camera 600 for shooting the mushroom pleats with a bottom view are deployed on the robot to obtain two-view images of mushrooms on the mushroom stick at the same time. Referring to FIG. 38, three images are shot for each taken mushroom stick and are combined into a batch. The batch is input into the mushroom object detection model to obtain the mushroom detection results from three views (a top view, a right bottom view and a left bottom view): det_d, det_ur and det_ul. The formats of det_d, det_ur and det_ul are all [id, x, y, w, h, conf, cls], where id is the serial number of the detection frame, x, y, w, h are the central coordinates of the detection frame, and the width and the height of the detection frame, conf is the category confidence, and cls is the category attribution of the target.

The purpose of multi-view target matching is to correlate the category information of the mushroom cap and the mushroom pleats of the identical target in the detection result, so as to comprehensively judge whether the mushroom meets the picking requirements. Since the installation positions and postures of the mushroom identification depth camera 403-12, the first depth camera 500 and the second depth camera 600 are controllable, such that the ranges of the mushroom stick in the visual fields of the three cameras are basically the same. A rule-based method can be used to match the mushroom cap with the mushroom pleats. Referring to the rightmost picture in FIG. 38, first, a detection frame in det_d is divided into an upper part det_dr and a lower part det_dl with a middle line of a picture in a width direction as a dividing line. The detection frame in the upper part det_dr corresponds to the detection result det_ur of a mushroom pleat image of a right bottom view of the mushroom stick. The detection frame in the lower part det_dl corresponds to the detection result det_ul of the mushroom pleat image of a left bottom view of the mushroom stick. The specific target matching process can take the upper part det_dr as an example, as shown in FIG. 39. For each mushroom cap target det_up in the upper part, the center point of the mushroom cap target det_up is (x_d, y_d), and the width is w_d. The width of the search range F specified in the x-axis direction is 1.5 times that of w_d. Thereafter, a detection frame list det_ups with the distance between the coordinate values x_u and x_d of the center point of the mushroom pleat target smaller than the width of the search range F is acquired in det_ur, that is, a detection frame list det_ups in a range slightly larger than the width of the mushroom cap target det_up in the x-axis direction is acquired in det_ur. Thereafter, the detection frame with a minimum coordinate value in the y-axis direction is selected from det_ups, which is the mushroom pleat target corresponding to the mushroom cap target det_up. Similarly, for each mushroom cap target det_down in the lower part det_dl, a detection frame list det_downs in a range slightly larger than the width of the mushroom cap target det_down in the x-axis direction is acquired in det_ul. Thereafter, the detection frame with a minimum coordinate value in the y-axis direction is selected from det_downs, which is the mushroom pleat target corresponding to the mushroom cap target det_down. Finally, according to the actual production requirements, a list of targets to be picked in a mushroom cap image of a top view is determined. The mushrooms in which the mushroom cap belongs to an abnormal category or the mushroom pleats belong to a fully open category do not meet the picking standard. The mushrooms in which the mushroom cap belongs to a white or normal category and the mushroom pleats belong to an un-open or slightly open category meet the picking standard. That is to say, the following four situations are targets to be picked: \textcircled{1}. the mushroom cap belongs to a white category, and the mushroom pleats belong to an un-open category; \textcircled{2}. the mushroom cap belongs to a white category, and the mushroom pleats belong to a slightly open category; \textcircled{3}. the mushroom cap belongs to a normal category, and the mushroom pleats belong to an un-open category; \textcircled{4}. the mushroom cap belongs to a normal category, and the mushroom pleats belong to a slightly open category. The mushrooms can be distinguished according to the quality grade in a decreasing order. The mushrooms in the case \textcircled{1} are special products. The mushrooms in the case \textcircled{2} are superior products. The mushrooms in the case \textcircled{3} are suboptimal products. The mushrooms in the case \textcircled{4} are ordinary products.

Step 3: the mushroom object detection model is deployed in a controller.

Step 4: the controller controls a robot arm and an execution end to act to perform a picking task.

Step (1): the mushroom stick take-up device 300 drives the mushroom stick 2 to move to a position close to the execution end 403 of the mushroom picking device 400, the controller controls the mechanical arm to act, so that the mushroom identification depth camera 403-12 reaches the shooting position above the mushroom stick, and the mushroom identification depth camera 403-12, the first depth camera 500 and the second depth camera 600 acquire RGB images and depth images of the mushroom stick, and send the RGB images and the depth images to the controller.

Step (2): the RGB images are input into the mushroom object detection model, and the target to be picked is identified through multi-view target matching.

Step (3): the controller obtains three-dimensional coordinates of a center point of the mushroom cap of the target to be picked, thereafter, converts the three-dimensional coordinates of the center point of the mushroom cap into position information in a base coordinate system of the mechanical arm through coordinate conversion, the mechanical arm acts to guide the execution end to move to the target to be picked, and the execution end executes the picking action to pick the mushroom target to be picked on the mushroom stick.

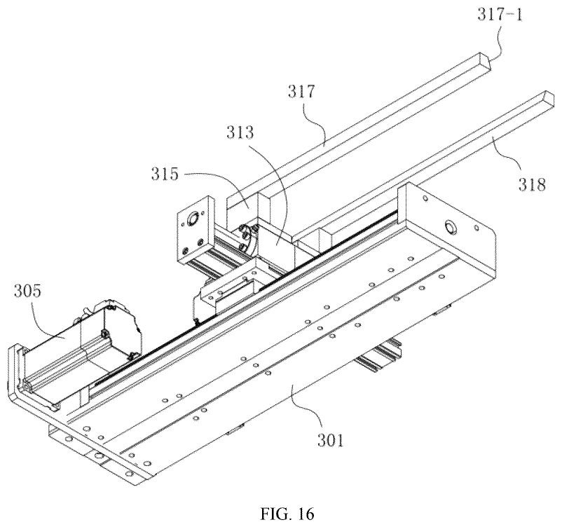

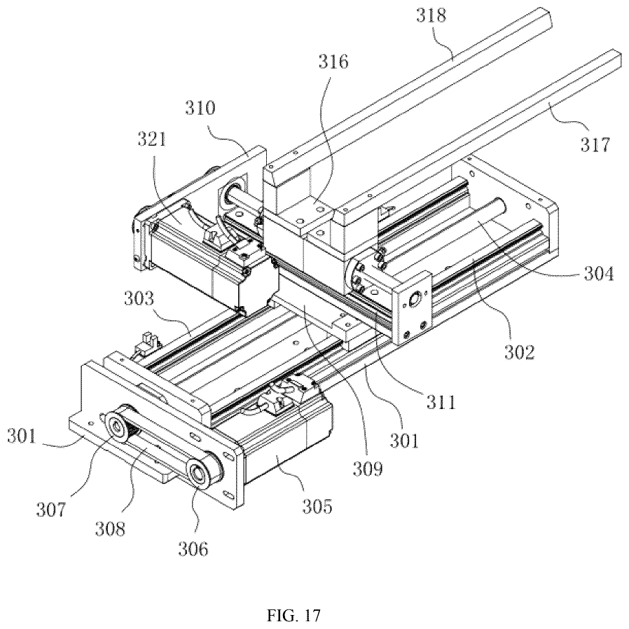

In addition, regarding the specific structure of the mushroom stick take-up device 300, in order to further optimize the clamping mushroom stick effect of the two clamping rods of the mushroom stick take-up device 300, as shown in FIG. 11, FIG. 17 and FIG. 16, an inner side of the clamping rod I 317 is provided with an inclined surface 317-1, and an inner side of the clamping rod II 318 is provided with an inclined surface 318-1. Referring to FIG. 35, since the outer side surface of the mushroom stick is a circular arc, the inclined surface 317-1 and the inclined surface 318-1 act at both sides of the mushroom stick, such that the mushroom stick can be clamped more stably and reliably.

It should be noted that a mobile platform can be installed on the chassis 100. The mobile platform is a conventional product in the prior art. The mobile platform is used to move the whole robot on the ground to a position convenient for the picking operation.

What has been described above is only the preferred embodiment of the present disclosure, rather than limit the present disclosure. For those skilled in the art, the present disclosure may have various modifications and changes. If those skilled in the art is inspired, the structural methods and embodiments similar to the technical scheme using other forms of part configurations, driving devices and connection methods without creative design should all fall within the scope of protection of the present disclosure without departing from the creative purpose of the present disclosure.

What is claimed is:

1. A factory mushroom picking robot, comprising a mobile platform, a chassis, a lifting device, a mushroom stick take-up device and a mushroom picking device, wherein the chassis is connected with the mobile platform, the lifting device is connected with the chassis, the mushroom stick take-up device is connected with the lifting device, and the mushroom picking device is connected with the chassis;
the lifting device comprises a first fixed plate, a second fixed plate, a first electric cylinder, a second electric cylinder and a support plate, wherein the first electric cylinder is fixedly connected with the first fixed plate, the second electric cylinder is fixedly connected with the second fixed plate, the first electric cylinder and the second electric cylinder are vertically arranged side by side, the first electric cylinder is provided with a first slider, the second electric cylinder is provided with a second slider, one end of the support plate is connected with the first slider on the first electric cylinder, and an other end of the support plate is connected with the second slider on the second electric cylinder; the first fixed plate is fixedly connected with the chassis, and the second fixed plate is fixedly connected with the chassis;
the mushroom stick take-up device comprises a first base, a first guide rail component, a second guide rail component, a Y-axis-direction screw rod, a nut, a first driving motor, a first synchronous belt wheel, a second synchronous belt wheel, a first synchronous belt, a sliding plate, a second base, a third guide rail component, an X-axis-direction bidirectional screw rod, a slider I, a slider II, an L-shaped connecting plate I, an L-shaped connecting plate II, a clamping rod I, a clamping rod II, a nut seat I, a nut seat II, a second driving motor, a third synchronous belt wheel, a fourth synchronous belt wheel, and a second synchronous belt, wherein the first guide rail component and the second guide rail component are fixedly connected with the first base, the first guide rail component and the second guide rail component are arranged side by side, a front end of the Y-axis-direction screw rod is rotatably connected with a front portion of the first base through a bearing, a rear end of the Y-axis-direction screw rod is rotatably connected with a rear portion of the first base through a bearing, the Y-axis-direction screw rod is located between the first guide rail component and the second guide rail component, the first driving motor is connected with a rear portion of the first base, the first synchronous belt wheel is connected with an output shaft of the first driving motor, the second synchronous belt wheel is connected with a rear end of the Y-axis-direction screw rod, the first synchronous belt is connected between the first synchronous belt wheel and the second synchronous belt wheel, the nut is connected with the Y-axis-direction screw rod, the sliding plate is fixedly connected with the nut, one side of the sliding plate is fixedly connected with the slider on the first guide rail component, an other side of the sliding plate is fixedly connected with the slider on the second guide rail component, the second base is fixedly connected with the sliding plate, the third guide rail component is fixedly connected with the second base, a left end of the X-axis-direction bidirectional screw rod is rotatably connected with a left portion of the second base through a bearing, a right end of the X-axis-direction bidirectional screw rod is rotatably connected with a right portion of the second base through a bearing, the nut seat I and the nut seat II are connected with the X-axis-direction bidirectional screw rod, the slider I is fixedly connected with the nut seat I, the slider II is fixedly connected with the nut seat II, the L-shaped connecting plate I is fixedly connected with the slider I, the L-shaped connecting plate II is fixedly connected with the slider II, the second driving motor is fixedly connected with a left portion of the second base, the third synchronous belt wheel is connected with an output shaft of the second driving motor, the fourth synchronous belt wheel is connected with a left end of the X-axis-direction bidirectional screw rod, the second synchronous belt is connected between the third synchronous belt wheel and the fourth synchronous belt wheel, a rear end of the clamping rod I is fixedly connected with the L-shaped connecting plate I, a rear end of the clamping rod II is fixedly connected with the L-shaped connecting plate II, and the first base is fixedly connected with the support plate of the lifting device;
the mushroom picking device comprises a lifting mechanism, a robot arm and an execution end, wherein the lifting mechanism is fixedly connected with the chassis, the robot arm is connected with the lifting mechanism, and the execution end is connected with a free end of the robot arm; the execution end comprises a support frame, a clamping driving motor, a screw rod, a screw rod nut, a connecting block, a first connecting rod, a first V-shaped connecting rod, a second connecting rod, a second V-shaped connecting rod, a first clamping block and a second clamping block, wherein the clamping driving motor is fixedly connected with the support frame, the screw rod is fixedly connected with an output shaft of the clamping driving motor, the screw rod nut is connected with the screw rod, the connecting block is fixedly connected with the screw rod nut, a rear end of the first connecting rod is rotatably connected with the connecting block, a front end of the first connecting rod is rotatably connected with a rear end of the first V-shaped connecting rod, a middle portion of the first V-shaped connecting rod is rotatably connected with the support frame, a rear end of the second connecting rod is rotatably connected with the connecting block, a front end of the second connecting rod is rotatably connected with a rear end of the second V-shaped connecting rod, a middle portion of the second V-shaped connecting rod is rotatably connected with the support frame, the first connecting rod and the second connecting rod are arranged symmetrically to each other, the first V-shaped connecting rod and the second V-shaped connecting rod are arranged symmetrically to each other, the first clamping block is connected with a front end of the first V-shaped connecting rod, and the second clamping block is connected with a front end of the second V-shaped connecting rod; the first clamping block is provided with an arc-shaped groove, and the second clamping block is provided with an arc-shaped groove;
the support frame of the execution end is fixedly connected with the free end of the robot arm;
the lifting mechanism is located between the first electric cylinder and the second electric cylinder of the lifting device.

2. The factory mushroom picking robot according to claim 1, wherein an inner side of the clamping rod I of the mushroom stick take-up device is provided with an inclined surface, and an inner side of the clamping rod II of the mushroom stick take-up device is provided with an inclined surface.

3. The factory mushroom picking robot according to claim 1, wherein the picking device further comprises a mushroom identification depth camera, and the mushroom identification depth camera is connected with the support frame of the execution end.

4. A vision-based graded picking method for a factory mushroom picking robot, wherein the factory mushroom picking robot comprises a mobile platform, a chassis, a lifting device, a mushroom stick take-up device and a mushroom picking device, wherein the chassis is connected with the mobile platform, the lifting device is connected with the chassis, the mushroom stick take-up device is connected with the lifting device, and the mushroom picking device is connected with the chassis;
the lifting device comprises a first fixed plate, a second fixed plate, a first electric cylinder, a second electric cylinder and a support plate, wherein the first electric cylinder is fixedly connected with the first fixed plate, the second electric cylinder is fixedly connected with the second fixed plate, the first electric cylinder and the second electric cylinder are vertically arranged side by side, the first electric cylinder is provided with a first slider, the second electric cylinder is provided with a second slider, one end of the support plate is connected with the first slider on the first electric cylinder, and an other end of the support plate is connected with the second slider on the second electric cylinder; the first fixed plate is fixedly connected with the chassis, and the second fixed plate is fixedly connected with the chassis;
the mushroom stick take-up device comprises a first base, a first guide rail component, a second guide rail component, a Y-axis-direction screw rod, a nut, a first driving motor, a first synchronous belt wheel, a second synchronous belt wheel, a first synchronous belt, a sliding plate, a second base, a third guide rail component, an X-axis-direction bidirectional screw rod, a slider I, a slider II, an L-shaped connecting plate I, an L-shaped connecting plate II, a clamping rod I, a clamping rod II, a nut seat I, a nut seat II, a second driving motor, a third synchronous belt wheel, a fourth synchronous belt wheel, and a second synchronous belt, wherein the first guide rail component and the second guide rail component are fixedly connected with the first base, the first guide rail component and the second guide rail component are arranged side by side, a front end of the Y-axis-direction screw rod is rotatably connected with a front portion of the first base through a bearing, a rear end of the Y-axis-direction screw rod is rotatably connected with a rear portion of the first base through a bearing, the Y-axis-direction screw rod is located between the first guide rail component and the second guide rail component, the first driving motor is connected with a rear portion of the first base, the first synchronous belt wheel is connected with an output shaft of the first driving motor, the second synchronous belt wheel is connected with a rear end of the Y-axis-direction screw rod, the first synchronous belt is connected between the first synchronous belt wheel and the second synchronous belt wheel, the nut is connected with the Y-axis-direction screw rod, the sliding plate is fixedly connected with the nut, one side of the sliding plate is fixedly connected with the slider on the first guide rail component, an other side of the sliding plate is fixedly connected with the slider on the second guide rail component, the second base is fixedly connected with the sliding plate, the third guide rail component is fixedly connected with the second base, a left end of the X-axis-direction bidirectional screw rod is rotatably connected with a left portion of the second base through a bearing, a right end of the X-axis-direction bidirectional screw rod is rotatably connected with a right portion of the second base through a bearing, the nut seat I and the nut seat II are connected with the X-axis-direction bidirectional screw rod, the slider I is fixedly connected with the nut seat I, the slider II is fixedly connected with the nut seat II, the L-shaped connecting plate I is fixedly connected with the slider I, the L-shaped connecting plate II is fixedly connected with the slider II, the second driving motor is fixedly connected with a left portion of the second base, the third synchronous belt wheel is connected with an output shaft of the second driving motor, the fourth synchronous belt wheel is connected with a left end of the X-axis-direction bidirectional screw rod, the second synchronous belt is connected between the third synchronous belt wheel and the fourth synchronous belt wheel, a rear end of the clamping rod I is fixedly connected with the L-shaped connecting plate I, a rear end of the clamping rod II is fixedly connected with the L-shaped connecting plate II, and the first base is fixedly connected with the support plate of the lifting device;
the mushroom picking device comprises a lifting mechanism, a robot arm and an execution end, wherein the lifting mechanism is fixedly connected with the chassis, the robot arm is connected with the lifting mechanism, and the execution end is connected with a free end of the robot arm; the execution end comprises a support frame, a clamping driving motor, a screw rod, a screw rod nut, a connecting block, a first connecting rod, a first V-shaped connecting rod, a second connecting rod, a second V-shaped connecting rod, a first clamping block and a second clamping block, wherein the clamping driving motor is fixedly connected with the support frame, the screw rod is fixedly connected with an output shaft of the clamping driving motor, the screw rod nut is connected with the screw rod, the connecting block is fixedly connected with the screw rod nut, a rear end of the first connecting rod is rotatably connected with the connecting block, a front end of the first connecting rod is rotatably connected with a rear end of the first V-shaped connecting rod, a middle portion of the first V-shaped connecting rod is rotatably connected with the support frame, a rear end of the second connecting rod is rotatably connected with the connecting block, a front end of the second connecting rod is rotatably connected with a rear end of the second V-shaped connecting rod, a middle portion of the second V-shaped connecting rod is rotatably connected with the support frame, the first connecting rod and the second connecting rod are arranged symmetrically to each other, the first V-shaped connecting rod and the second V-shaped connecting rod are arranged symmetrically to each other, the first clamping block is connected with a front end of the first V-shaped connecting rod, and the second clamping block is connected with a front end of the second V-shaped connecting rod; the first clamping block is provided with an arc-shaped groove, and the second clamping block is provided with an arc-shaped groove;
the support frame of the execution end is fixedly connected with the free end of the robot arm;
the lifting mechanism is located between the first electric cylinder and the second electric cylinder of the lifting device;
the picking device further comprises a mushroom identification depth camera, the mushroom identification depth camera is connected with the support frame of the execution end, the support plate is connected with a first depth camera through a first adjustable bracket, and the support plate is connected with a second depth camera through a second adjustable bracket;
the vision-based graded picking method comprising:
step 1: constructing a multi-view data set for training a mushroom object detection model;
step (1): acquiring video data of a mushroom stick using a depth camera, wherein the depth camera is initially located directly above the mushroom stick with an overhead shot looking down, and after video shooting, is moved around a side of the mushroom stick at a constant speed and stops recording video data upon being moved to a lower left side of the mushroom stick and having mushroom pleats be shot upward, so as to complete acquisition of a first video data of the mushroom stick; thereafter, recording a second video data, wherein the depth camera is initially located directly above the mushroom stick with an overhead shot looking down, and after video shooting, is moved around a side of the mushroom stick at a constant speed and stops recording video data upon being moved to the lower right side of the mushroom stick and having mushroom pleats be shot upward, so as to complete acquisition of a second video data of the mushroom stick; and acquiring a plurality of videos for a plurality of mushroom sticks;
step (2): obtaining still images of mushrooms, comprising: obtaining frame-extracted images by extracting frames from each video stream of the plurality of mushroom sticks, and screening a set of a large number of mushroom object detection data from the frame-extracted images, wherein the mushroom object detection data set comprises mushroom cap images with a top view and mushroom pleat images with a bottom view;
step (3): labeling the data set according to six quality categories comprising white, normal, abnormal, un-open, slightly open and fully open;
step 2: training the mushroom object detection model based on a YOLOv8 deep learning algorithm;
step (1): training the model;
based on a basic structure of a YOLOv8 object detection model, pruning a detection head of a P3 layer, a P5 feature layer and a detection head of a P5 layer, and retaining only an output of a detection head of a P4 layer, thus forming the mushroom object detection model; and training the mushroom object detection model by using the mushroom object detection data set constructed in the step 1;
step (2): performing a multi-view target matching, wherein the mushroom cap with a top view is shot using the mushroom identification depth camera, the mushroom pleats with a bottom view are shot using the first depth camera and the second depth camera, the three images shot by the mushroom identification depth camera, the first depth camera and the second depth camera are combined into a batch, the batch is input into the mushroom object detection model to obtain mushroom detection results from three views comprising the top view, a right bottom view and a left bottom view: det_d, det_ur and det_ul; the mushroom cap is matched with the mushroom pleats using a rule-based method, first, a detection frame in det_d is divided into an upper part det_dr and a lower part det_dl with a middle line of a picture in a width direction as a dividing line such that the detection frame in the upper part det_dr corresponds to the detection result det_ur of a mushroom pleat image from the right bottom view of the mushroom stick, and the detection frame in the lower part det_dl corresponds to the detection result det_ul of a mushroom pleat image from the left bottom view of the mushroom stick; a list of targets to be picked in a mushroom cap image with the top view is determined, and the targets to be picked comprise following four situations: \textcircled{1}. the mushroom cap belongs to a white category, and the mushroom pleats belong to an un-open category; \textcircled{2}. the mushroom cap belongs to the white category, and the mushroom pleats belong to a slightly open category; \textcircled{3}. the mushroom cap belongs to a normal category, and the mushroom pleats belong to the un-open category; \textcircled{4}. the mushroom cap belongs to the normal category, and the mushroom pleats belong to the slightly open category;
step 3: deploying the mushroom object detection model in a controller;
step 4: controlling, by the controller, a robot arm and the execution end to act to perform a picking task;
step (1): driving, by the mushroom stick take-up device, the mushroom stick to move to a position close to the execution end of the mushroom picking device, controlling, by the controller, the robot arm to act, so that the mushroom identification depth camera reaches a shooting position above the mushroom stick, and acquiring, by the mushroom identification depth camera, the first depth camera and the second depth camera, RGB images and depth images of the mushroom stick, and transmitting the RGB images and the depth images to the controller;
step (2): inputting the RGB images into the mushroom object detection model, and identifying the target to be picked through multi-view target matching;
step (3): obtaining, by the controller, three-dimensional coordinates of a center point of a mushroom cap of the target to be picked, thereafter, converting the three-dimensional coordinates of the center point of the mushroom cap into position information in a base coordinate system of the robot arm through coordinate conversion, guiding, by action of the robot arm, the execution end to move to the target to be picked, and picking mushroom targets to be picked on the mushroom stick by the execution end executing the picking action.

5. The vision-based graded picking method according to claim 4, wherein in a process of the multi-view target matching, for each mushroom cap target det_up in the upper part det_dr, a detection frame list det_ups in a range slightly larger than a width of the mushroom cap target det_up in the x-axis direction is acquired in det_ur, thereafter, a detection frame with a minimum coordinate value in the y-axis direction is selected from det_ups, as the mushroom pleat target corresponding to the mushroom cap target det_up; for each mushroom cap target det_down in the lower part det_dl, a detection frame list det_downs in a range slightly larger than a width of the mushroom cap target det_down in the x-axis direction is acquired in det_ul, thereafter, a detection frame with a minimum coordinate value in the y-axis direction is selected from det_downs, as the mushroom pleat target corresponding to the mushroom cap target det_down.

6. The vision-based graded picking method according to claim 4, wherein in the step (2) of the step 1, the frame-extracted images are preliminarily screened by an image quality evaluation method, and are subjected to manual inspection to remove the images containing incomplete mushroom sticks, and then image frames extracted in first few seconds and last few seconds of an original video are selected from inspected images, and finally the mushroom object detection data set is obtained.

7. A mushroom detection and grading method based on multi-view fusion, comprising following steps:
step 1: constructing a multi-view data set for training a mushroom object detection model;
step (1): acquiring video data of a mushroom stick using a depth camera, wherein a depth camera is initially located directly above the mushroom stick with an overhead shot looking down, and after video shooting, is moved around a side of the mushroom stick at a constant speed and stops recording video data upon being moved to a lower left side of the mushroom stick and having mushroom pleats be shot upward, so as to complete acquisition of a first video data of the mushroom stick; thereafter, recording a second video data, wherein the depth camera is initially located directly above the mushroom stick with an overhead shot looking down, and after video shooting, is moved around a side of the mushroom stick at a constant speed and stops recording video data upon being moved to a lower right side of the mushroom stick and having mushroom pleats being shot upward, so as to complete acquisition of a second video data of the mushroom stick; and acquiring a plurality of videos for a plurality of mushroom sticks;
step (2): obtaining still images of mushrooms, comprising: obtaining frame-extracted images by extracting frames from each video stream of the plurality of mushroom sticks, and screening a set of a large number of mushroom object detection data from the frame-extracted images, wherein the mushroom object detection data set comprises mushroom cap images with a top view and mushroom pleat images with a bottom view;
step (3): labeling the data set according to six quality categories comprising white, normal, abnormal, un-open, slightly open and fully open;
step 2: training the mushroom object detection model based on a YOLOv8 deep learning algorithm;
step (1): training the model;
using a YOLOv8 object detection model as the mushroom object detection model, and training the mushroom object detection model by using the mushroom object detection data set constructed in the step 1;
step (2): performing multi-view target matching; wherein three images of the mushroom stick shot by a mushroom identification depth camera, a first depth camera and a second depth camera are combined into a batch, the batch is input into the mushroom object detection model to obtain mushroom detection results from three views comprising a top view, a right bottom view and a left bottom view: det_d, det_ur and det_ul; a mushroom cap is matched with the mushroom pleats using a rule-based method, first, a detection frame in det_d is divided into an upper part det_dr and a lower part det_dl with a middle line of a picture in a width direction as a dividing line such that the detection frame in the upper part det_dr corresponds to the detection result det_ur of a mushroom pleat image from the right bottom view of the mushroom stick, and the detection frame in the lower part det_dl corresponds to the detection result det_ul of a mushroom pleat image from the left bottom view of the mushroom stick; a list of targets to be picked in a mushroom cap image with the top view is determined, and the targets to be picked comprise the following four situations: \textcircled{1}. the mushroom cap belongs to a white category, and the mushroom pleats belong to an un-open category; \textcircled{2}. the mushroom cap belongs to the white category, and the mushroom pleats belong to a slightly open category; \textcircled{3}. the mushroom cap belongs to a normal category, and the mushroom pleats belong to the un-open category; \textcircled{4}. the mushroom cap belongs to the normal category, and the mushroom pleats belong to the slightly open category.

8. The mushroom detection and grading method based on multi-view fusion according to claim 7, wherein in the step (2) of the step 1, the frame-extracted images are preliminarily screened by an image quality evaluation method and are subjected to manual inspection to the images containing incomplete mushroom sticks, and then image frames extracted in first few seconds and last few seconds of an original video are selected from inspected images, and finally the mushroom object detection data set is obtained.

9. The mushroom detection and grading method based on multi-view fusion according to claim 7, wherein in the step 2, the mushroom object detection model is formed by pruning a detection head of a P3 layer and an entire P5 layer, and retaining only an output of a detection head of a P4 layer based on a basic structure of the YOLOv8 object detection model.

10. A non-transitory storage medium on which a computer program is stored, wherein the computer program, when being executed by a processor, implements:
step 1: constructing a multi-view data set for training a mushroom object detection model;
step (1): acquiring video data of a mushroom stick using a depth camera, wherein a depth camera is initially located directly above the mushroom stick with an overhead shot looking down, and after video shooting, is moved around a side of the mushroom stick at a constant speed and stops recording video data upon being moved to a lower left side of the mushroom stick and having mushroom pleats be shot upward, so as to complete acquisition of a first video data of the mushroom stick; thereafter, recording a second video data, wherein the depth camera is initially located directly above the mushroom stick with an overhead shot looking down, and after video shooting, is moved around a side of the mushroom stick at a constant speed and stops recording video data upon being moved to a lower right side of the mushroom stick and having mushroom pleats being shot upward, so as to complete acquisition of a second video data of the mushroom stick; and acquiring a plurality of videos for a plurality of mushroom sticks;
step (2): obtaining still images of mushrooms, comprising: obtaining frame-extracted images by extracting frames from each video stream of the plurality of mushroom sticks, and screening a set of a large number of mushroom object detection data from the frame-extracted images, wherein the mushroom object detection data set comprises mushroom cap images with a top view and mushroom pleat images with a bottom view;
step (3): labeling the data set according to six quality categories comprising white, normal, abnormal, un-open, slightly open and fully open;
step 2: training the mushroom object detection model based on a YOLOv8 deep learning algorithm;
step (1): training the model;
using a YOLOv8 object detection model as the mushroom object detection model, and training the mushroom object detection model by using the mushroom object detection data set constructed in the step 1;
step (2): performing multi-view target matching; wherein three images of the mushroom stick shot by a mushroom identification depth camera, a first depth camera and a second depth camera are combined into a batch, the batch is input into the mushroom object detection model to obtain mushroom detection results from three views comprising a top view, a right bottom view and a left bottom view: det_d, det_ur and det_ul; a mushroom cap is matched with the mushroom pleats using a rule-based method, first, a detection frame in det_d is divided into an upper part det_dr and a lower part det_dl with a middle line of a picture in a width direction as a dividing line such that the detection frame in the upper part det_dr corresponds to the detection result det_ur of a mushroom pleat image from the right bottom view of the mushroom stick, and the detection frame in the lower part det_dl corresponds to the detection result det_ul of a mushroom pleat image from the left bottom view of the mushroom stick; a list of targets to be picked in a mushroom cap image with the top view is determined, and the targets to be picked comprise the following four situations: \textcircled{1}. the mushroom cap belongs to a white category, and the mushroom pleats belong to an un-open category; \textcircled{2}. the mushroom cap belongs to the white category, and the mushroom pleats belong to a slightly open category; \textcircled{3}. the mushroom cap belongs to a normal category, and the mushroom pleats belong to the un-open category; \textcircled{4}. the mushroom cap belongs to the normal category, and the mushroom pleats belong to the slightly open category.

11. The non-transitory storage medium according to claim 10, wherein in the step (2) of the step 1, the frame-extracted images are preliminarily screened by an image quality evaluation method and are subjected to manual inspection to the images containing incomplete mushroom sticks, and then image frames extracted in first few seconds and last few seconds of an original video are selected from inspected images, and finally the mushroom object detection data set is obtained.

12. The non-transitory storage medium according to claim 10, in the step 2, the mushroom object detection model is formed by pruning a detection head of a P3 layer and an entire P5, and retaining only an output of a detection head of a P4 layer based on a basic structure of the YOLOv8 object detection model.
